(19) United States
(12) Patent Application Publication
(10) Pub. No.: US 2026/0072542 A1
(43) Pub. Date: Mar. 12, 2026

(54) NON-CONTACT INPUT DEVICE AND INPUT ASSISTANCE APPLICATION

(71) Applicant: Alps Alpine Co., Ltd., Tokyo (JP)

(72) Inventors: Yasuhiro MAEDA, Tokyo (JP); Keitaro UCHIDA, Miyagi (JP); Masataka SEO, Tokyo (JP); Yasuji HAGIWARA, Tokyo (JP); Masahiro TAKATA, Miyagi (JP)

(21) Appl. No.: 19/384,193

(22) Filed: Nov. 10, 2025

Related U.S. Application Data
(63) Continuation of application No. PCT/JP2024/007967, filed on Mar. 4, 2024.

(30) Foreign Application Priority Data
May 11, 2023 (JP) 2023-078754

(51) Int. Cl. G06F 3/041; G06F 3/044; G06F 3/04812; G06F 3/04886

(52) U.S. Cl. CPC G06F 3/04166; G06F 3/04812; G06F 3/04886; G06F 3/0443; G06F 2203/04101; G06F 2203/04803

(57) ABSTRACT

A non-contact input device includes an operation surface, a detection unit that measures a two-dimensional position of an object with which a non-contact operation is performed on the operation surface and a distance from the operation surface to the object, a display disposed on a back side of the operation surface, a control device including an OS utilizing a flat GUI and an input assistance application, wherein the input assistance application outputs, to the OS, a command to display, on the display, a second pointer in an overlay, the second pointer being different from a first pointer displayed by the OS on the display, according to the two-dimensional position and the distance, and when it is determined that an operation with the object is decided based on the two-dimensional position and the distance, outputs, to the OS, the two-dimensional position when the operation is decided and a click event.

### CLAIM OF PRIORITY

This application is a Continuation of International Application No. PCT/JP2024/007967 filed on Mar. 4, 2024, which claims benefit of Japanese Patent Application No. 2023-078754 filed on May 11, 2023. The entire contents of each application noted above are hereby incorporated by reference.

### BACKGROUND OF THE INVENTION

### 1. Field of the Invention

The present disclosure relates to a non-contact input device and an input assistance application.

### 2. Description of the Related Art

In the related art, an input terminal device that receives a user operation via a position input object includes a position detection unit that non-contact detects the position of the position input object operated by the user, a display unit that displays a pointer based on the position detected by the position detection unit, and an operation processing control unit that executes the corresponding operation process based on the position detected by the position detection unit. The operation processing control unit has a plurality of operation modes for executing the operation process, one of the operation modes includes a state where no operation process other than moving the pointer according to the position of the position input object is performed, and the operation processing control unit switches between the plurality of operation modes in a case where the user performs a specific operation via the position input object (for example, see US 2018/0292970 A1). It is known to change the size of the pointer in accordance with to which position on the operation screen the hand is directed and the distance between the hand and the operation screen based on the three-dimensional spatial position of the hand approaching the operation screen (for example, Japanese Unexamined Patent Application No. 2010-244422).

The input terminal device in the related art uses a dedicated application program capable of detecting three-dimensional positions in order to non-contact detect the three-dimensional position of the position input object (object). Therefore, it is impossible to implement the input terminal device in the related art using a device equipped with an application program that can handle only the two-dimensional position.

Therefore, the present invention is to provide a non-contact input device and an input assistance application that enables non-contact input through the three-dimensional operation, the non-contact input device including the application program that can handle only the two-dimensional position.

### SUMMARY OF THE INVENTION

A non-contact input device according to an embodiment of the present disclosure includes an operation surface, a detection unit that measures a two-dimensional position of an object with which a non-contact operation is performed on the operation surface and a distance from the operation surface to the object, a display disposed on a back side of the operation surface, a control device including an OS utilizing a flat GUI and an input assistance application, wherein the input assistance application outputs, to the OS, a command to display, on the display, a second pointer in an overlay, the second pointer being different from a first pointer displayed by the OS on the display, in accordance with the two-dimensional position and the distance, and outputs, to the OS, the two-dimensional position and a click event based on the two-dimensional position and the distance.

### BRIEF DESCRIPTION OF THE DRAWINGS

FIG. 1 is a diagram showing an example of the configuration of a non-contact input device of the embodiment;

FIG. 2 is a diagram showing an example of the configuration of an electrostatic sensor and control device, and the like of the non-contact input device of the embodiment;

FIG. 3 is a diagram showing an example of four regions corresponding to the Z-direction distance from the operation surface of the non-contact input device of the embodiment;

FIG. 4 is a diagram describing an OS of the control unit, an input assistance application, and a predetermined application program of the non-contact input device of the embodiment;

FIG. 5A is a diagram describing the position accuracy metric of the object in the non-contact input device of the embodiment;

FIG. 5B is a diagram describing the position accuracy metric of the object in the non-contact input device of the embodiment;

FIG. 5C is a diagram describing the position accuracy metric of the object in the non-contact input device of the embodiment;

FIG. 6A is a diagram showing an example of display of a display of the non-contact input device of the embodiment;

FIG. 6B is a diagram showing an example of display of a display of the non-contact input device of the embodiment;

FIG. 6C is a diagram showing an example of display of a display of the non-contact input device of the embodiment;

FIG. 6D is a diagram showing an example of display of a display of the non-contact input device of the embodiment;

FIG. 6E is a diagram showing an example of display of a display of the non-contact input device of the embodiment;

FIG. 6F is a diagram showing an example of display of a display of the non-contact input device of the embodiment;

FIG. 7A is a diagram showing an example of a process performed by the input assistance application of the non-contact input device of the embodiment;

FIG. 7B is a diagram showing an example of a process performed by the input assistance application of the non-contact input device of the embodiment;

FIG. 7C is a diagram showing an example of a process performed by the input assistance application of the non-contact input device of the embodiment;

FIG. 7D is a diagram showing an example of a modification of the process performed by the input assistance application of the non-contact input device of the embodiment;

FIG. 8A is a diagram showing an example of a process performed by the input assistance application of the non-contact input device of the embodiment;

FIG. 8B is a diagram showing an example of a process performed by the input assistance application of the non-contact input device of the embodiment;

FIG. 8C is a diagram showing an example of a process performed by the input assistance application of the non-contact input device of the embodiment;

FIG. 8D is a diagram showing an example of a process performed by the input assistance application of the non-contact input device of the embodiment;

FIG. 8E is a diagram showing an example of a process performed by the input assistance application of the non-contact input device of the embodiment;

FIG. 8F is a diagram showing an example of a process performed by the input assistance application of the non-contact input device of the embodiment;

FIG. 9A is a diagram showing an example of a process performed by the input assistance application of the non-contact input device of the embodiment;

FIG. 9B is a diagram showing an example of a process performed by the input assistance application of the non-contact input device of the embodiment;

FIG. 9C is a diagram showing an example of a process performed by the input assistance application of the non-contact input device of the embodiment;

FIG. 9D is a diagram showing an example of a process performed by the input assistance application of the non-contact input device of the embodiment;

FIG. 9E is a diagram showing an example of a process performed by the input assistance application of the non-contact input device of the embodiment;

FIG. 9F is a diagram showing an example of a process performed by the input assistance application of the non-contact input device in the embodiment;

FIG. 10 is a diagram showing an example of a settings screen;

FIG. 11 is a diagram showing an example of a folder configuration; and

FIG. 12 is a flowchart showing an example of the setting process.

### DESCRIPTION OF THE PREFERRED EMBODIMENTS

In the following, an embodiment applying the non-contact input device and the input assistance application in the present disclosure is described.

### EMBODIMENTS

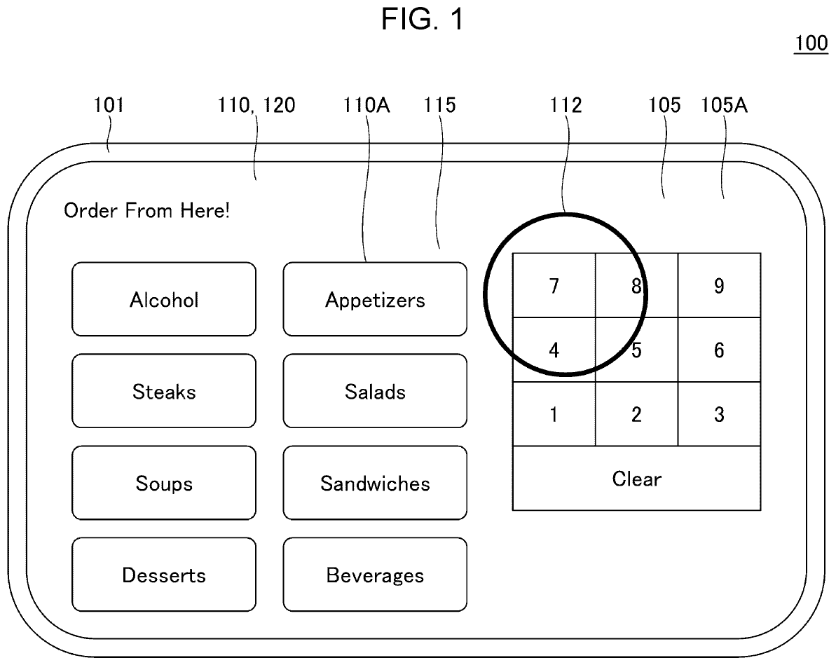

FIG. 1 is a diagram showing an example of the configuration of a non-contact input device 100 of the embodiment. FIG. 1 shows the state in which a display 110 displays an input image.

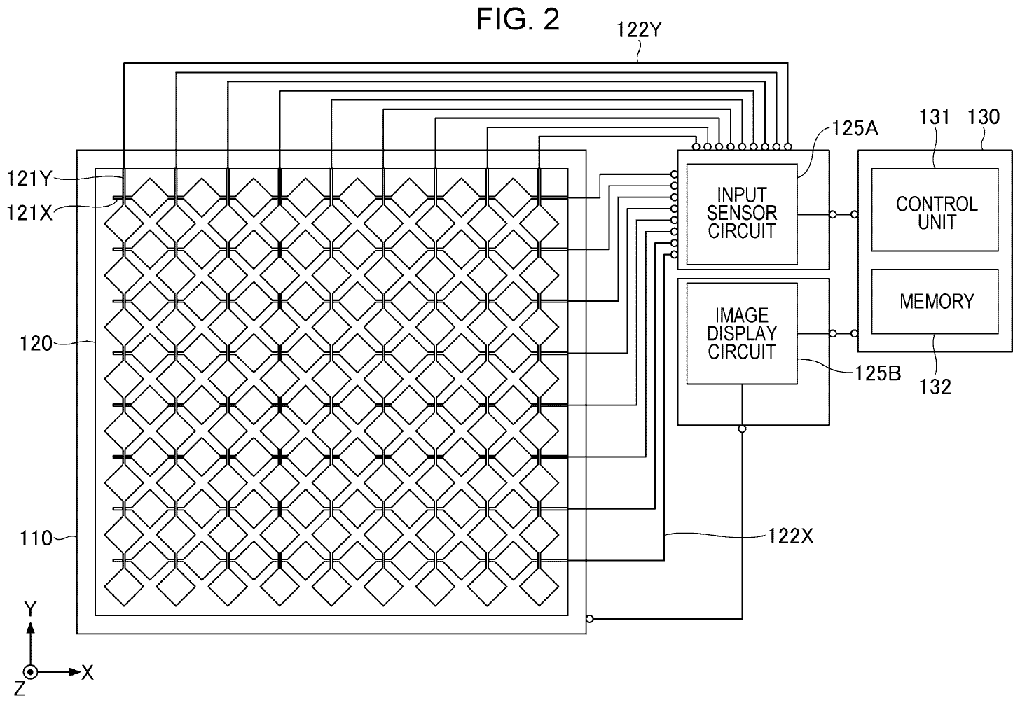

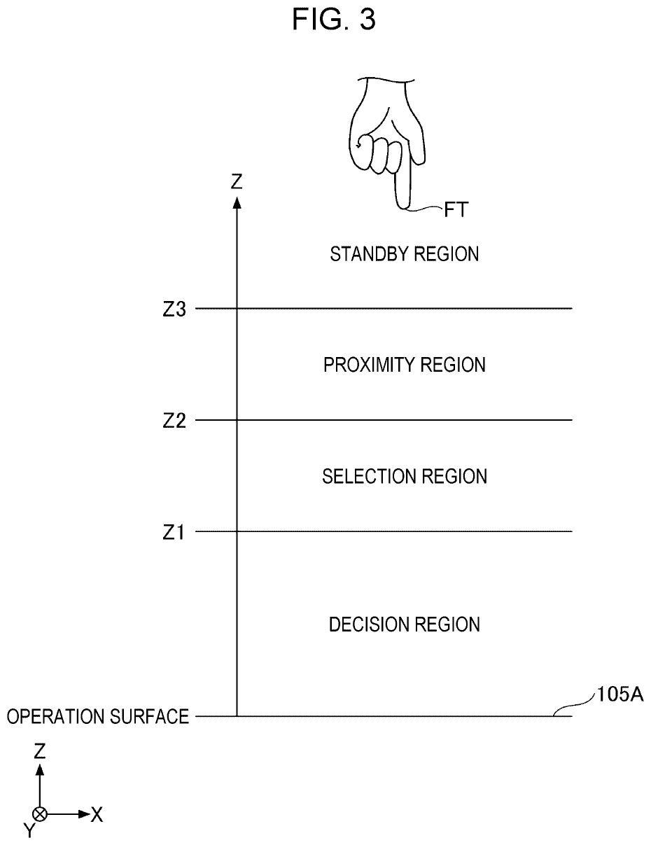

FIG. 2 is a diagram showing an example of the configuration of an electrostatic sensor 120, a control device 130, and the like of the non-contact input device 100. FIG. 3 is a diagram showing four regions corresponding to the distance in the Z direction from an operation surface 105A of the non-contact input device 100.

In the following description, the XYZ coordinate system is defined and described. The X axis is a first axis, the Y axis is a second axis, and the Z axis is a third axis. The direction parallel to the X axis (X-direction), the direction parallel to the Y axis (Y-direction), and the direction parallel to the Z axis (Z-direction) are mutually orthogonal. Furthermore, in the following description, the −Z direction is defined as a direction approaching the electrostatic sensor 120, and the +Z direction is defined as a direction away from the electrostatic sensor 120. Furthermore, plan view refers to viewing the XY plane. Additionally, to make the structure easier to understand, the length, thickness, and width of each part may be exaggerated for illustrative purposes.

The non-contact input device 100 may be, for example, a tablet-type input device or an input unit of an automatic teller machine (ATM) placed in locations such as stores or facilities and used by an unspecified number of users. Alternatively, it may be the input unit of cooking appliances that require maintaining a clean state.

### <Overall Configuration Of Non-Contact Input Device 100>

The non-contact input device 100 includes a housing 101, a top panel 105, the display 110, an electrostatic sensor 120, an input sensor circuit 125A, an image display circuit 125B, and a control device 130. The input sensor circuit 125A calculates the XYZ coordinates from the measurement results of the electrostatic sensor 120. FIG. 1 omits the control device 130 (see FIG. 2), but the control device 130 is provided, as an example, below the display 110 and the electrostatic sensor 120 inside the housing 101. The non-contact input device 100 includes the electrostatic sensor 120 and the control device 130 shown in FIG. 2.

### <Housing 101 And Top Panel 105>

The housing 101 is a case made of resin, metal, or similar material that accommodates the display 110, the electrostatic sensor 120, and the control device 130. The display 110 is positioned below the transparent electrostatic sensor 120 and is visible through the operation surface 105A, which is the top surface of the transparent top panel 105 installed in the opening at the top of the housing 101. The electrostatic sensor 120 may be retrofitted to the existing display 110. The display and the control device 130 may be integrated, as in a tablet computer. The display and the control device 130 may be separate components as in a desktop computer.

### <Four Regions Of The Non-Contact Input Device 100 And Operation Methods>

The non-contact input device 100 can be operated in a state in which the pointing body such as a user's hand is in a non-contact state relative to the operation surface 105A, and a state in which the pointing body such as a user's hand is in a contact state relative to the operation surface 105A. Here, a description is given together with the modes executed by the input assistance application of the non-contact input device 100. The input assistance application has four modes: a decision mode; a selection mode; a proximity mode; and a standby mode.

The non-contact input device 100 is an input device operated by the user performing a pointing operation. The pointing operation refers to an operation performed with a finger held substantially perpendicular to the operation surface 105A. The number of fingers used for the pointing operation may be plural, but is preferably one.

When performing such a pointing operation, in a case where the finger is not held substantially perpendicular to the operation surface 105A, the entire palm approaches the operation surface 105A, making it difficult to measure the position of a fingertip FT.

Unless otherwise specified, the description is made to a case where the user performs a pointing operation using the fingertip FT as a pointing body. Additionally, in the following description, performing an operation (a proximity operation, a selection operation, a decision operation, or a contact operation) using the fingertip FT will be expressed simply as performing an operation (a proximity operation, a selection operation, a decision operation, or a contact operation) using the fingertip FT.

The method of operating the non-contact input device 100 includes three types: a proximity operation; a selection operation; and a decision operation.

The non-contact input device 100 uses four regions shown in FIG. 3 to distinguish between four operation methods. The four regions, in order from the operation surface 105A, are a decision region, a selection region, a proximity region, and a standby region.

### <Decision Region, Selection Region, Proximity Region, And Standby Region>

The decision region is a first region where the Z-direction distance from the operation surface 105A is less than Z1 (for example, 2 cm), and where the input assistance application sets the mode of the input assistance application to the decision mode. Z1 is an example of a first threshold value. In a case where the input assistance application determines that the fingertip FT is positioned in the decision region, the decision operation is performed. Furthermore, a distance of 0 cm (contact) from the operation surface 105A in the Z direction is included in the decision region. Note that the relationship between the Z axis distance and the capacitance is subject to individual variation and the influence of the installation environment. However, when the operator and operating environment are identical, the capacitance is inversely proportional to the Z axis distance. Therefore, in a case where it is sufficient to measure the relative distance with respect to the same operator, the capacitance can be treated as a distance. Details of the decision region and the decision operation will be described later.

The input assistance application uses a value (Z value) proportional to the capacitance between the fingertip FT and the electrostatic sensor 120 instead of the Z axis distance. The input sensor circuit 125A calculates a position (XY coordinates) of the fingertip FT facing the operation surface 105A and a value (Z value) proportional to the capacitance between the operation surface 105A and the fingertip FT, based on the capacitance at the plurality of intersections of a plurality of sensor electrodes 121X and a plurality of sensor electrodes 121Y.

The decision region is a region where the Z value is greater than Cz1 (for example, 60). Cz1 is a value proportional to the capacitance corresponding to the distance Z1. Cz1 is an example of the first threshold value. In the embodiment, the position when the fingertip FT touches the operation surface 105A is included in the decision region. It can be determined from the Z value that the fingertip FT has touched the operation surface 105A. For example, it is possible to design the system so that the Z value is 100 when the fingertip FT lightly touches the operation surface 105A. When the Z value is greater than 100, it may be determined that the fingertip FT is located in the contact region, and the operation may be performed as the contact mode.

The selection region is a second region where the distance from the operation surface 105A is Z1 or greater, and shorter than Z2 (for example, 4 cm), which is longer than Z1, and is a region where the input assistance application sets the mode of the input assistance application to the selection mode. Z2 is an example of a second threshold value. When the input assistance application determines that the fingertip FT is positioned in the selection region, a selection operation is performed. Details of the selection operation will be described later.

The selection region is a region where the Z value is greater than Cz2 (for example, 40) and less than or equal to Cz1. Cz2 is a value smaller than Cz1. Cz2 and Cz1 are values proportional to the capacitance corresponding to distances Z2 and Z1, respectively. The capacitance Cz2 is an example of the second threshold value.

The proximity region is a third region where the distance from the operation surface 105A is Z2 or greater, and shorter than Z3 (for example, 7 cm), which is longer than Z2, and is a region where the input assistance application sets the mode of the input assistance application to the proximity mode. Z3 is an example of a third threshold value. When the input assistance application determines that the fingertip FT is positioned in the proximity region, the proximity operation is performed. The proximity region is a region that is farthest from the operation surface 105A among the regions where the XY coordinates of the object can be calculated. Details of the proximity operation will be described later.

The proximity region is a region where the Z value is greater than Cz3 (for example, 10) and less than or equal to Cz2. Cz3 is a value smaller than Cz2. Cz3 and Cz2 are values proportional to the capacitance corresponding to distances Z3 and Z2, respectively. Cz3 is an example of a third threshold value.

The standby region is a fourth region where the distance from the operation surface 105A is longer than Z3, and is a region where the input assistance application sets the mode of the input assistance application to the standby mode. The standby region is a region where the Z value is Cz3 or less. Furthermore, the capacitance value measured in a case where no fingertip FT is present around the operation surface 105A is equal to the reference value. Calibration is performed so that the Z value is zero when there is no fingertip FT around the operation surface 105A. An input assistance API may turn off the display power in the standby mode.

### <Proximity Operation, Selection Operation, Decision Operation, And Contact Operation>

The proximity operation refers to an operation of bringing the fingertip FT close to the operation surface 105A of the non-contact input device 100 without touching the operation surface 105A, and for switching the display 110 from the standby mode display to the proximity mode display.

The selection operation is an operation of bringing the fingertip FT to further closer to the operation surface 105A of the non-contact input device 100 without touching the operation surface 105A from a state where the proximity operation has been performed, and for selecting a GUI button displayed on the display 110.

The decision operation is an operation of bringing the fingertip FT further closer to the operation surface 105A of the non-contact input device 100 without touching the operation surface 105A from a state where the selection operation is performed, and for issuing a click event. When a click event is generated above the GUI button, an OS 140 and an application program 160 decide the operation input. The decision operation involves performing a non-contact operation input, specifically operating the non-contact input device 100 without touching the operation surface 105A with the fingertip FT. The operation input performed through the non-contact selection operation and the decision operation may be referred to as a hover input or a touchless input. Additionally, even when the fingertip FT touches the operation surface 105A of the non-contact input device 100, the mode may be treated as the decision mode. Alternatively, in a case where the fingertip FT touches the operation surface 105A of the non-contact input device 100, the input may be confirmed immediately. Alternatively, in a case where the fingertip FT touches the operation surface 105A of the non-contact input device 100, a warning screen may be displayed.

### <Display 110>

Examples of the display 110 include a liquid crystal display, an organic electroluminescent display, and the like. The display 110 is a display for achieving a graphic user interface (GUI). The display 110 displays the image provided by the OS graphical shell (desktop screen, and the like, not shown), a second pointer 112 displayed by an input assistance application 150 in an overlay, and an application software image 115. The input assistance application 150 displays the second pointer 112 in an overlay by setting the Z-order of the second pointer 112 to the topmost position (closest to the viewpoint). The application software image 115 includes the image of a GUI button 110A. The GUI button 110A is an operation portion, and as an example, has a shape modeled after a push button. The application software is designed with the assumption that the application software will be operated using two-dimensional position input devices such as a mouse.

FIG. 1 shows an example of a restaurant ordering terminal screen. The order screen displays a total of 17 GUI buttons 110A: eight GUI buttons 110A for the menu; and nine GUI buttons 110A in a ten key format such as a numeric keypad. The 17 GUI buttons 110A are disposed in three or four rows in the Y direction and five rows in the X direction. The rows extend in the X direction, and the columns extend in the Y direction. Note that the GUI button 110A is not limited to being used for the screen of a restaurant ordering terminal, but may be used in other applications as long as it is a touch panel operation screen.

### <Electrostatic Sensor 120, Input Sensor Circuit 125A, Image Display Circuit 125B>

The electrostatic sensor 120 is superimposed on the display 110 and, as shown in FIG. 2, has the plurality of sensor electrodes 121X extending in the X direction and the plurality of sensor electrodes 121Y extending in the Y direction. Furthermore, the electrostatic sensor 120 is integrally provided with the input sensor circuit 125A. Additionally, the display 110 is integrally provided with the image display circuit 125B. The input sensor circuit 125A is connected between wiring 122X, 122Y and the control device 130. The image display circuit 125B is connected between the display 110 and the control device 130.

The sensor electrodes 121X and 121Y are connected to the control device 130 via the wiring 122X, 122Y, and the input sensor circuit 125A. Such an electrostatic sensor 120 may be configured such that a transparent conductive film, such as indium tin oxide (ITO), is formed on the surface of the transparent glass, and the sensor electrodes 121X, 121Y, and the wiring 122X, 122Y are patterned. The capacitance detected by the electrostatic sensor 120 is input to the control device 130.

FIG. 2 shows the plurality of sensor electrodes 121X and the plurality of sensor electrodes 121Y. It is preferable that the spacing between the sensor electrodes 121X and the spacing between the sensor electrodes 121Y be narrower than the spacing between the GUI buttons 110A. In other words, it is preferable to use the electrostatic sensor 120 corresponding to the spacing between the GUI buttons 110A.

The input sensor circuit 125A is mounted on the wiring board. The input sensor circuit 125A is provided between the wiring 122X, 122Y and control device 130 and performs analog-to-digital (AD) conversion of the capacitance of the electrostatic sensor 120, the capacitance being acquired by sequentially selecting a plurality of lines of the wiring 122X and a plurality of lines of the wiring 122Y. The input sensor circuit 125A calculates the XY coordinates of the fingertip FT and the Z value proportional to the capacitance value between the operation surface 105A and the fingertip FT from the capacitance values of each wiring. The input sensor circuit 125A is capable of generating the XY output in the same format as a contact-operated digitizer, as well as generating the XYZ output in its own unique format. The input assistance application 150 transmits a command to stop the XY output in the digitizer format to the input sensor circuit 125A via the coordinate device driver. The input assistance application 150 performs the process based on the XYZ output. The image display circuit 125B is provided between the display 110 and the control device 130, and displays an image on the display 110 according to image data transmitted from the control device 130.

### <Control Device 130>

The control device 130 includes a control unit 131 and a memory 132. The control device 130 is achieved by a computer including a central processing unit (CPU), a random access memory (RAM), a read-only memory (ROM), an input/output interface, and an internal bus. The control unit 131 represents the function of the program executed by the control device 130 as a functional block. Furthermore, the memory 132 functionally represents the memory of the control device 130.

The control unit 131 controls the operation of the non-contact input device 100. The control unit 131 receives the XY coordinates and the Z value input from the input sensor circuit 125A. The control unit 131 controls the display of the image on the display 110 via the image display circuit 125B. The control unit 131 outputs a command corresponding to the operation content decided by the decision operation of the fingertip FT. For example, when the non-contact input device 100 is an ordering terminal at a restaurant, the non-contact input device 100 transmits the name and the quantity of the dishes ordered by the customer to the order management terminal at the kitchen.

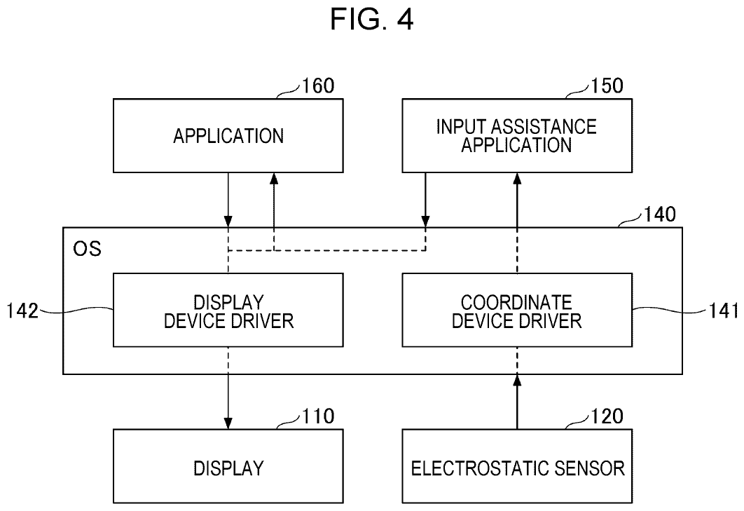

The control unit 131 includes an OS utilizing a flat GUI, a coordinate device driver, a display device driver, an input assistance application, and a predetermined application program. Here, FIG. 4 is used to describe the OS, the input assistance application, and the predetermined application program. FIG. 4 is a diagram describing the OS of the control unit 131, the input assistance application, and the predetermined application program.

FIG. 4 shows the OS 140 possessed by the control unit 131, the input assistance application 150, and the application program 160. The OS 140 is an operating system (OS) that utilizes a flat GUI, such as Windows (registered trademark) or Android (registered trademark). The OS utilizing a flat GUI does not provide a user interface (UI) suitable for 3D input. The application program 160 is an application program for restaurant ordering terminals and the like.

The OS 140 includes a coordinate device driver 141 and a display device driver 142. The coordinate device driver 141 passes the XY coordinates and the Z value input from the electrostatic sensor 120 to the input assistance application 150. When receiving the XY coordinates and the click event from the input assistance application 150, the OS 140 causes the application program 160 to execute the command corresponding to the button at the input XY coordinates. Additionally, the OS 140 passes, to the display device driver 142, the image data to be displayed, the XY position of the image to be displayed, and the Z-order (order of distance from the viewpoint) of the image to be displayed. The input assistance application 150 sets the Z-order of the second pointer 112 to the topmost position.

The display device driver 142 performs control to display the second pointer 112 at the XY coordinates input from the input assistance application 150, display the image according to the command input from the application program 160 when a decision operation is performed, and the like. Note that the OS treats the second pointer 112 as a simple image.

The input assistance application 150 is an application that provides input assistance to a user utilizing the non-contact input device 100. The input assistance application 150 may perform processing to calculate a position accuracy metric of the fingertip FT. The input assistance application 150 performs the process of causing the OS 140 to display an image of the second pointer 112, which is different from a first pointer 111 displayed on the display 110 by the OS 140, based on the XY coordinates of the fingertip FT and a position accuracy metric. Additionally, in a case where a decision operation is performed, the input assistance application 150 outputs the XY coordinates at the time of the decision operation to the OS 140 as a position of the mouse pointer, and then issues a click event. The OS 140 notifies the application program 160 that the GUI button corresponding to the position of the mouse pointer when the click event is issued has been pressed. Other processes executed by the input assistance application 150 and details of each process will be described later.

The application program 160 is created assuming that the program is operated with a standard mouse or touch panel (that outputs two-dimensional coordinates). The application program 160 performs the process corresponding to the clicked GUI button when notified by the OS 140 that a click event has been issued on the GUI button.

The display 110, the control device 130, the OS 140, the display device driver 142, and the application program 160 may be existing devices that do not support the 3D input (non-contact input). By attaching the non-contact input-capable electrostatic sensor 120 to the existing display 110 and installing the coordinate device driver 141 and the input assistance application 150 on the control device 130, the existing display 110 can be used as a non-contact input device.

### <Calculation Of XY Coordinates And Z Value By Input Sensor Circuit 125A>

The input sensor circuit 125A scans the plurality of sensor electrodes 121X row by row and scans the plurality of sensor electrodes 121Y column by column, converting the capacitance at the plurality of intersections between the plurality of sensor electrodes 121X and the plurality of sensor electrodes 121Y into digital values. The control unit 131 counts the change in the output of the digital values corresponding to the capacitance and calculates a differential value ΔAD at each intersection. The difference value ΔAD is a count value corresponding to the change in the output of the input sensor circuit 125A relative to the reference value. The reference value is a value proportional to the capacitance at each intersection of the sensor electrodes 121X and 121Y in a case where no object such as the fingertip FT is present around the sensor electrodes 121X and 121Y. The input sensor circuit 125A calculates the XY coordinates on the display facing the fingertip FT from the differential value at each intersection, and selects the maximum ΔAD among the differential values ΔAD at respective intersections as the Z value. The Z value is a value proportional to the capacitance between the fingertip FT and the operation surface. Furthermore, the XY coordinates and the Z value may be calculated by the control unit 131.

Furthermore, by using an interpolation method, it is possible to increase the resolution from the spacing between the sensor electrodes 121X and the spacing between the sensor electrodes 121Y. In this case, the spacing between the sensor electrodes 121X and the spacing between the sensor electrodes 121Y may be wider than the spacing between the GUI buttons 110A. Additionally, the coordinate device driver 141 may calculate the XY coordinates and the Z value. In a case where the coordinate device driver 141 calculates the XY coordinates and the Z value, the hardware performing the calculation is the control unit 131.

### <Position Accuracy Metric Of Object>

The input assistance application 150 determines a position accuracy metric of the object when displaying the second pointer 112 on the display 110. The object is an object whose XY coordinates and Z-direction distance from the operation surface 105A can be obtained based on the capacitance between the object and the electrostatic sensor 120, and is a portion of a user's body, such as the user's hand or fingertip, interacting with the non-contact input device 100. Here, the position accuracy metric of the object is described.

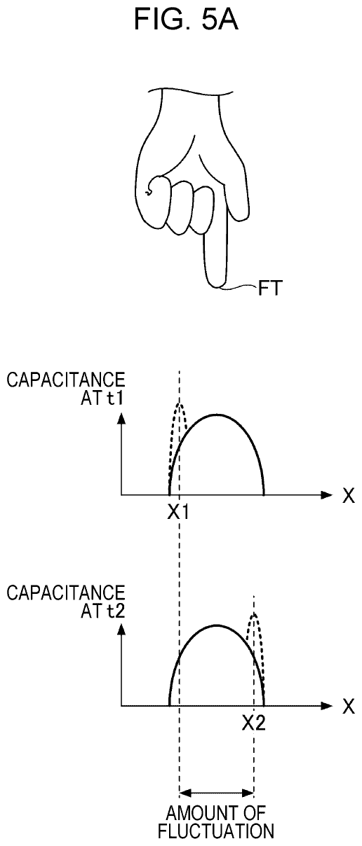

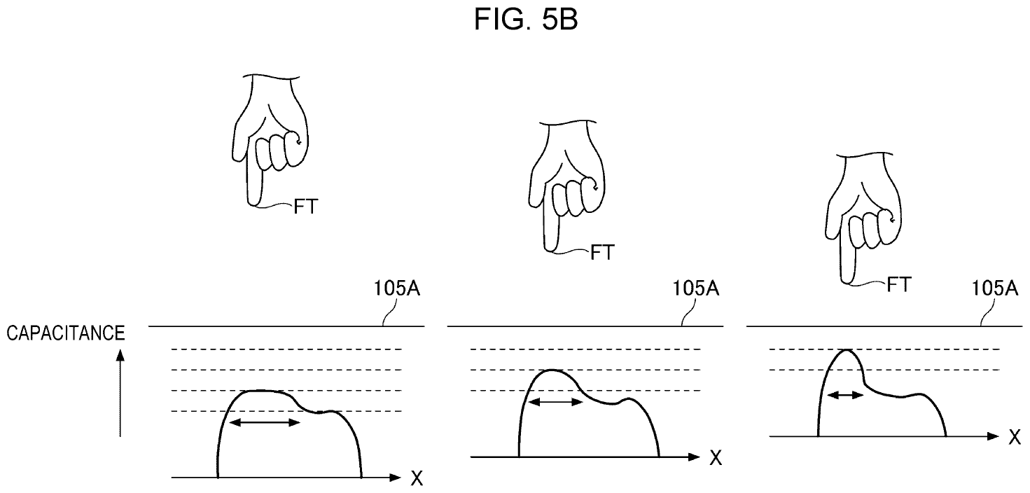

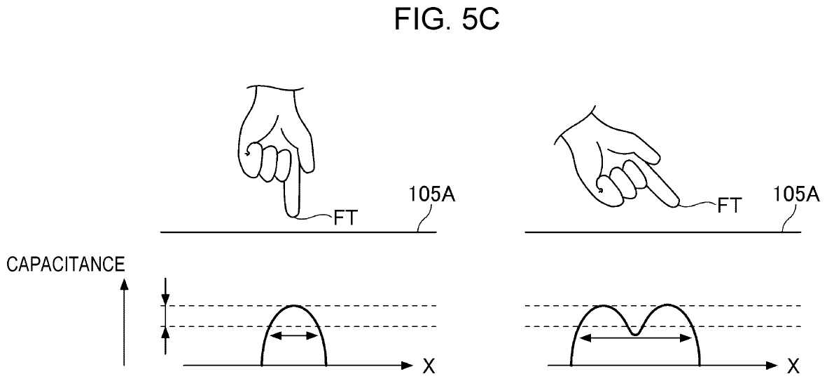

FIGS. 5A and 5B are diagrams describing the position accuracy metric of the object. The non-contact input device 100 uses the amount of fluctuation in the XY coordinates (two-dimensional position) of the fingertip FT as a position accuracy metric of the object.

FIG. 5A shows an example of the distribution of the capacitance in the X direction measured at times t1 and t2. It is assumed that at time t1, the X coordinate of the fingertip FT is calculated as X1, and at time t2, the X coordinate of the fingertip FT is calculated as X2.

Even when the fingertip FT is not being moved, the X coordinate fluctuates due to noise. The difference between the X coordinate X1 at time t1 and the X coordinate X2 at time t2 manifests as an amount of coordinate fluctuation. Note that the same applies to the Y coordinate.

The non-contact input device 100 uses the amount of coordinate fluctuation measured within a certain period of time as a position accuracy metric. More specifically, the standard deviation of the measured coordinates is used as a position accuracy metric. For example, in a case where a circle with a radius of 1σ of the standard deviation is set as the second pointer 112, the probability that the finger is located in the second pointer 112 is approximately 68%. In a case where a circle with a radius of 2σ is set as the second pointer 112, the probability that the finger is located in the second pointer 112 is approximately 95%. In this way, representing position accuracy by the size of the pointer allows for intuitive feedback of position accuracy to the user.

FIG. 5B shows an example of the distribution of the capacitance in the X direction in a case where the operation is performed with the fingertip FT held vertically relative to the operation surface 105A and gradually brought closer to the operation surface 105A. The fingertip FT on the left side in FIG. 5B is farthest from the operation surface 105A, while the fingertip FT on the right side in FIG. 5B is closest to the operation surface 105A. Both arrows in FIG. 5B indicate the range in which the capacitance is detected. FIG. 5B shows the distribution of the capacitance in the X-direction. As explained in FIG. 5C, the same applies to the distribution of the capacitance in the Y-direction.

In a case where the fingertip FT is far from the operation surface 105A (left side), the electrostatic sensor 120 is affected by the fingertip FT over a wide region, resulting in a flat capacitance distribution. When the magnitude of noise is the spacing between the two lines indicated by the dotted line, the range that could potentially be detected as the X coordinate of the fingertip FT is a range in which the capacitance is greater than the lower dotted line. In other words, the range in the X direction where the fingertip FT may be detected is the wide region indicated by the arrow in the left and right direction.

Furthermore, in a case where the fingertip FT is closer to the operation surface 105A (right side), the electrostatic sensor 120 is affected by the fingertip FT within a narrow range, resulting in a steep capacitance distribution. When the magnitude of noise is the spacing between the two lines indicated by the dotted line, the range that could potentially be detected as the X coordinate of the fingertip FT is a range in which the capacitance is greater than the lower dotted line. In other words, the range in the X direction where the fingertip FT may be detected is the narrow range indicated by the arrow in the left and right direction.

Furthermore, as shown in the center of FIG. 5B, in a case where the distance from the operation surface 105A to the fingertip FT is intermediate, the distribution of the capacitance in the X-direction is an intermediate distribution between the gentle distribution on the left and the steep distribution on the right.

Thus, the range in which the measured XY coordinates fluctuate due to noise is larger in a case where the fingertip FT is farther from the operation surface 105A (left side) than in a case where the fingertip FT is closer to the operation surface 105A (right side). The larger the area where the capacitance is detected, the greater the amount of coordinate fluctuation.

FIG. 5C shows an example of the capacitance distribution in the X-direction in a case of performing an operation with the fingertip FT held vertically relative to the operation surface 105A (left side) and in a case of performing an operation with the fingertip FT held horizontally relative to the operation surface 105A (right side). Both arrows indicate the range in which the capacitance is detected. FIG. 5C shows the distribution of the capacitance in the X direction, and the same applies to the distribution of the capacitance in the Y direction.

As shown on the left side of FIG. 5C, in a case of performing an operation with the fingertip FT held vertically, the capacitance distribution is steep, and the range in which the fingertip FT is detected narrows. As shown on the right side of FIG. 5C, in a case of performing an operation with the fingertip FT held horizontally and the palm close to the operation surface 105A, the distribution of the capacitance is flatter, resulting in that a range in which the fingertip FT is detected is wider.

Thus, the measured amount of fluctuation in the XY coordinates caused by noise is greater in a case of performing an operation with the fingertip FT held horizontally, as shown on the right side of FIG. 5C, than in a case of performing an operation with the fingertip FT held vertically, as shown on the left side of FIG. 5C.

As explained using FIGS. 5A, 5B, and 5C above, the amount of fluctuation in the measured XY coordinates due to noise varies depending on the distance from the fingertip FT to the operation surface 105A and the orientation of the fingertip FT, and the like. Furthermore, the amount of fluctuation changes depending on the magnitude of noise. Furthermore, in a case where the fingertip FT is actually moved, the amount of fluctuation increases. Even though the amount of fluctuation is large for any reason, the measurement accuracy is poor, so that the second pointer 112 is displayed in a large size. Additionally, when the amount of fluctuation is smaller, the second pointer 112 is displayed in a smaller size. This allows position accuracy to be represented by the size of the second pointer, providing a user with intuitive feedback on position accuracy.

Furthermore, as explained using FIG. 5C, the measured amount of fluctuation in the XY coordinates is greater in a case of performing an operation with the fingertip FT held horizontally and the palm close to the operation surface 105A than in a case of performing an operation with the fingertip FT held vertically. Therefore, in a case where the amount of fluctuation in the XY coordinates exceeds a predetermined threshold value, the non-contact input device 100 may determine that the operation is performed with the fingertip FT not held vertically near the operation surface 105A and may display a message prompting the operation to be performed with the fingertip FT held vertically near the operation surface 105A.

### <Calculation Of XY Coordinates Of Object (Calculation Of Moving Average)>

As explained using FIGS. 5A to 5C, since the XY coordinates calculated by the input sensor circuit 125A exhibit the amount of fluctuation, the input assistance application 150 calculates, as the XY coordinates of the fingertip FT, the moving average of the X coordinates acquired at a plurality of time points and the moving average of the Y coordinates acquired at a plurality of time points. The plurality of time points refers to a plurality of the most recent time points used to calculate the moving average, with intervals between time points being a few milliseconds.

The input assistance application 150 outputs, to the OS 140, a command to display the image of the second pointer at the XY coordinates calculated as a moving average.

The XY coordinates of the fingertip FT detected by the non-contact input device 100 using the electrostatic sensor 120 represent, as an example, the XY coordinates of the position with the largest capacitance in the region where the fingertip FT is present. Furthermore, the center of gravity position of a shape composed of a plurality of points where the difference from the largest capacitance is below the threshold value may be regarded as the XY coordinates of the fingertip FT. Furthermore, the X coordinate (or Y coordinate) of the vertex obtained by fitting the capacitance at a position with the largest capacitance and the capacitances at the three points adjacent to the position in the X direction (or the Y direction) to a quadratic curve may be regarded as the X (or Y) coordinate of the fingertip FT. Furthermore, capacitance is inversely proportional to distance. The capacitance and the distance have a one-to-one correspondence, so that the capacitance can be used instead of the distance. Furthermore, in the non-contact input device 100 of the present invention, it is not necessary to express the unit of capacitance in farads [F]. In the present invention, a value proportional to the capacitance is referred to as the Z value. The input sensor circuit 125A is designed so that the Z value when the fingertip FT contacts the operation surface 105A is approximately 100, and the Z value when the fingertip FT is not near the operation surface 105A is approximately 0.

The input assistance application 150 may cease calculating the moving average of XY coordinates or the amount of fluctuation in XY coordinates in a case of the proximity mode or the standby mode. Additionally, in the standby mode, the display power may be turned off.

### <Calculation Of Index Of Object Position Accuracy Metric By Input Assistance Application 150>

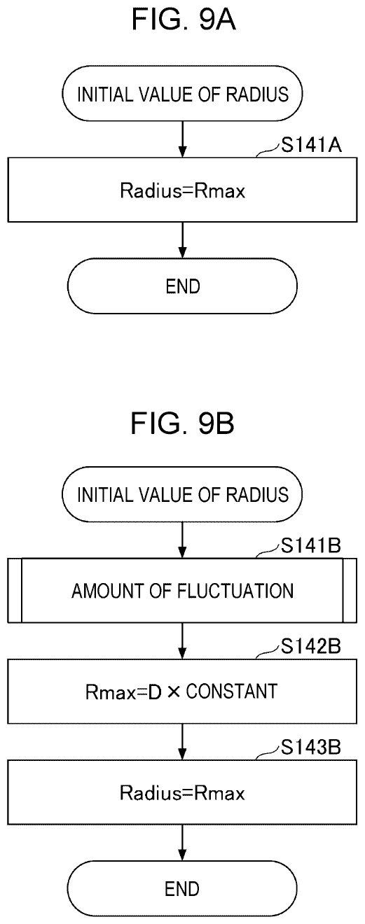

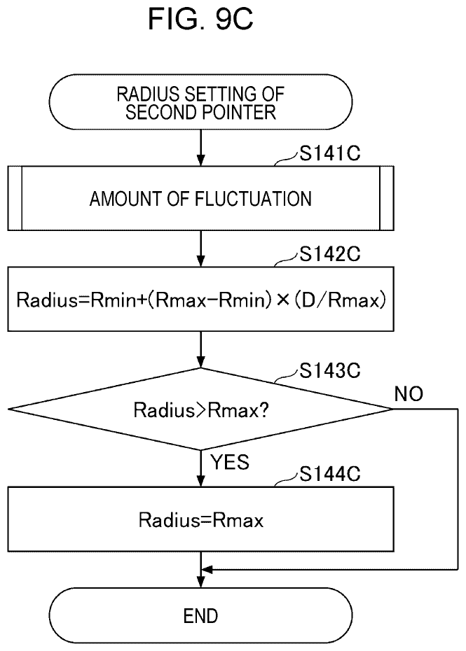

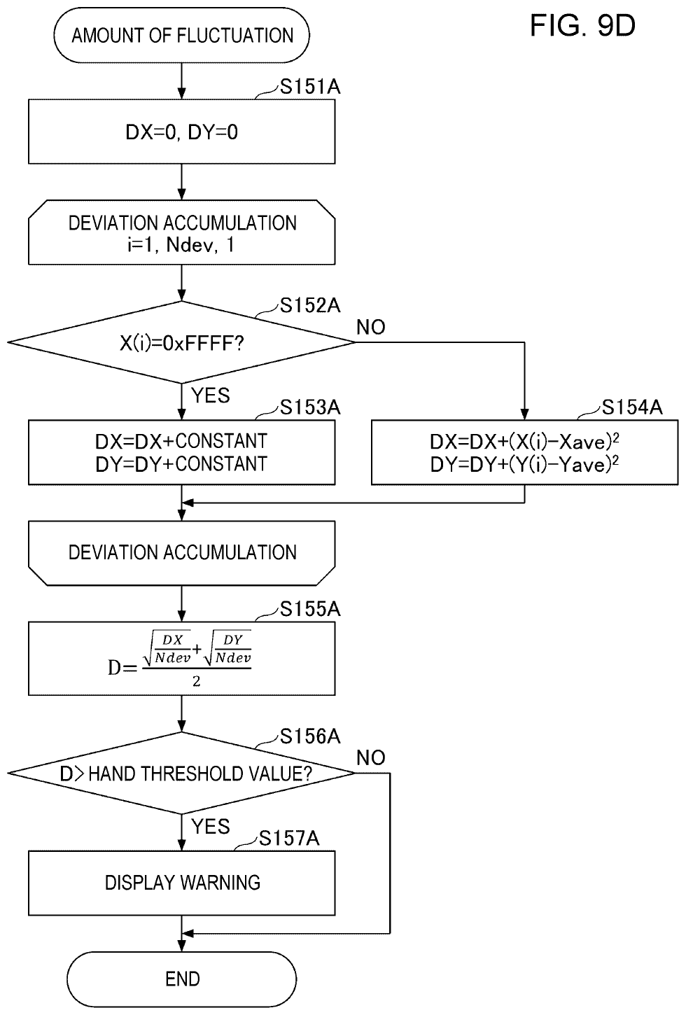

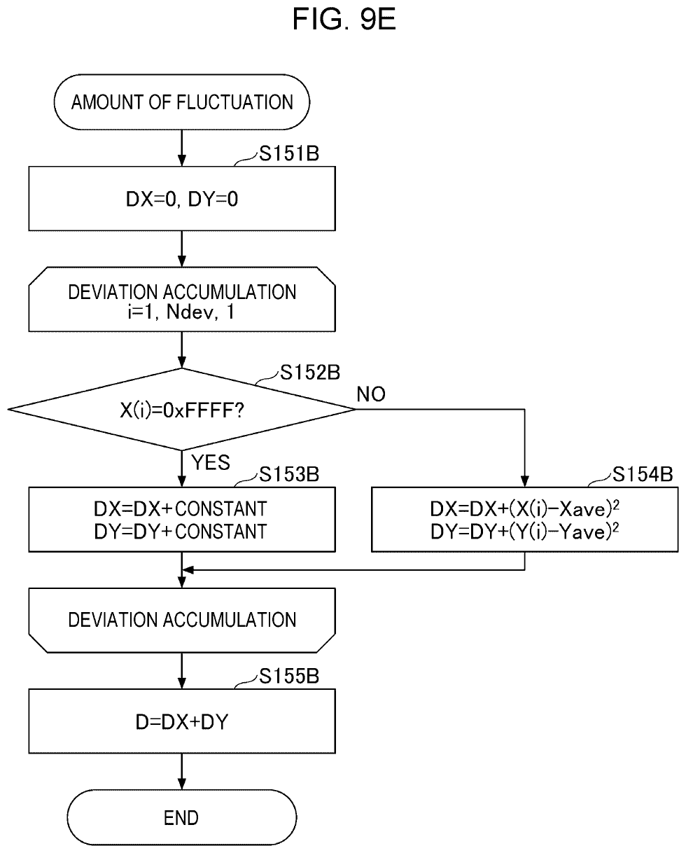

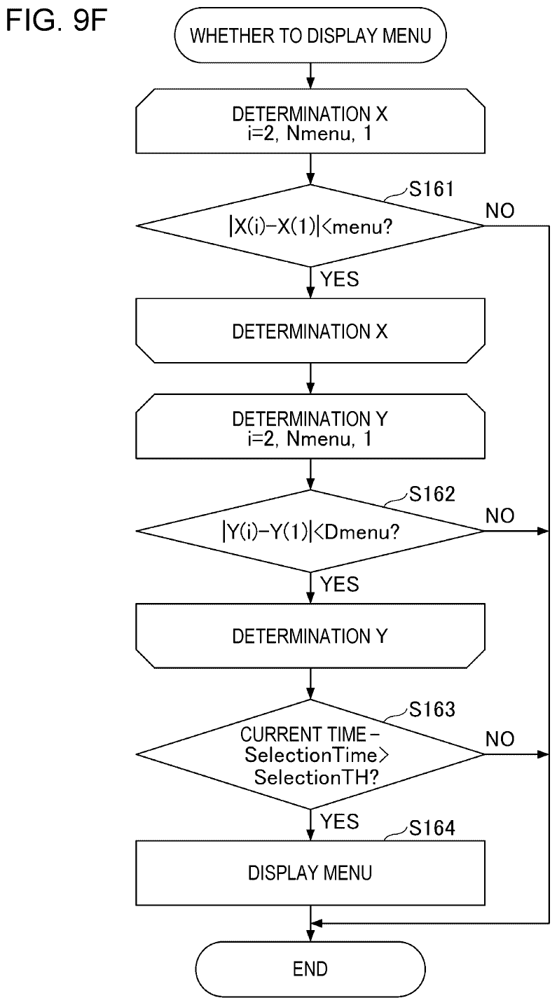

To indicate the magnitude of error caused by the amount of fluctuation in the XY coordinates measured by the non-contact input device 100, the input assistance application 150 calculates the standard deviation of the XY coordinates as the position accuracy metric of the object. The method of calculating the standard deviation of the XY coordinates will be described later using FIG. 9D.

### <Display Example Of Non-Contact Input Device 100>

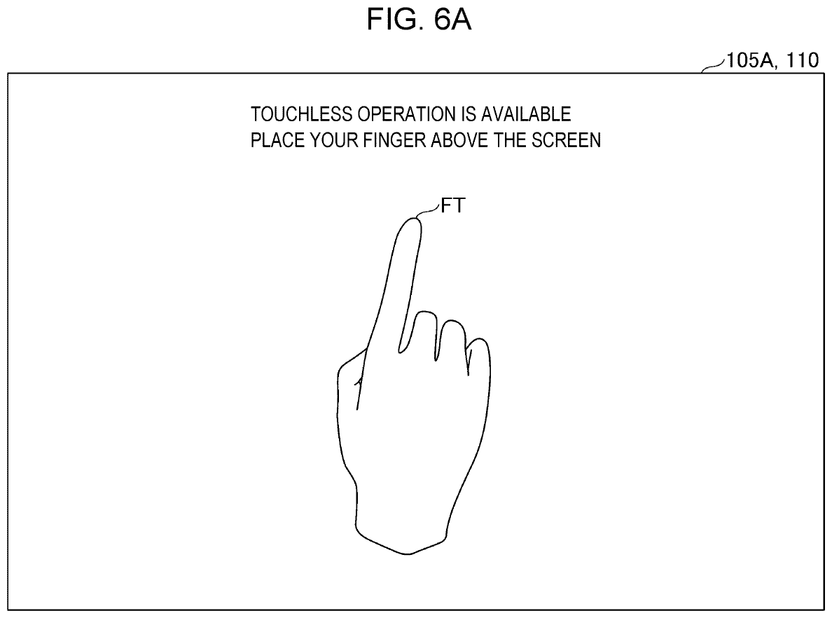

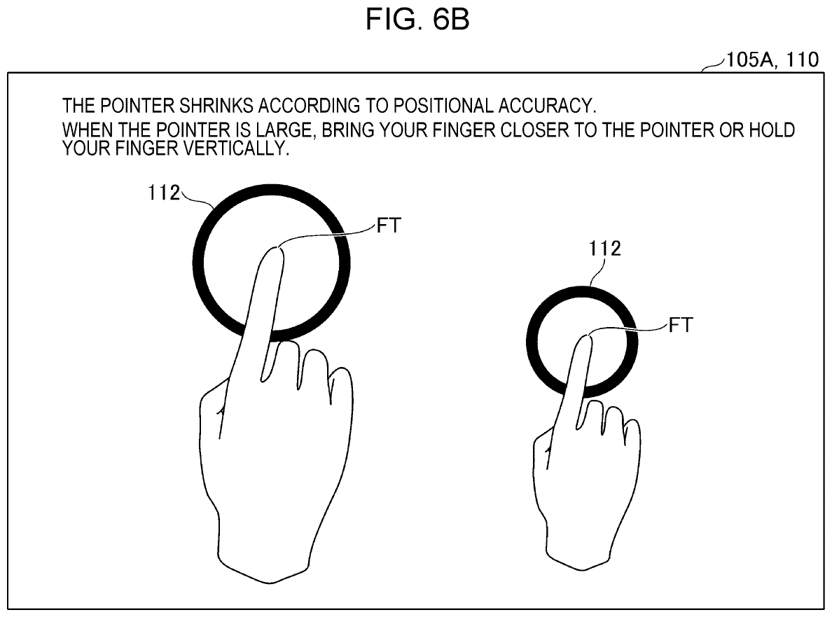

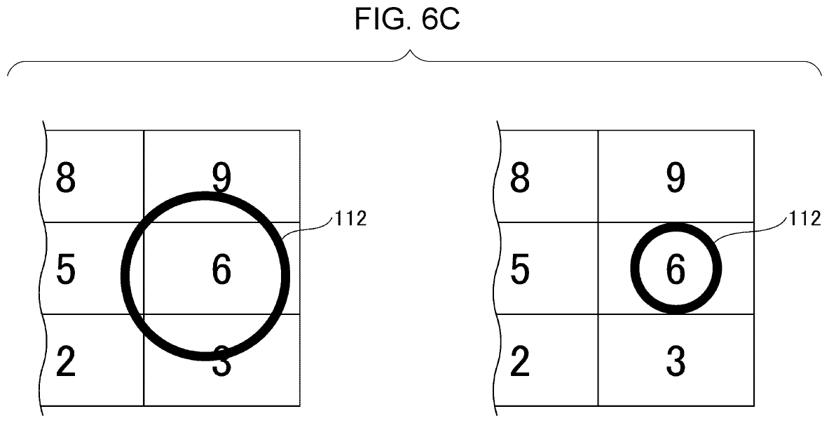

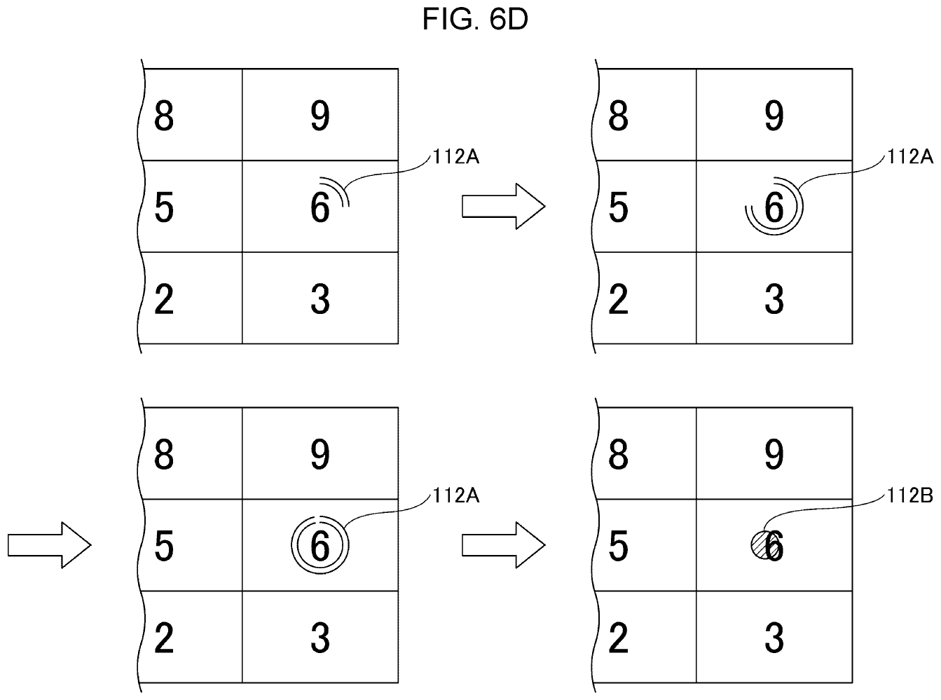

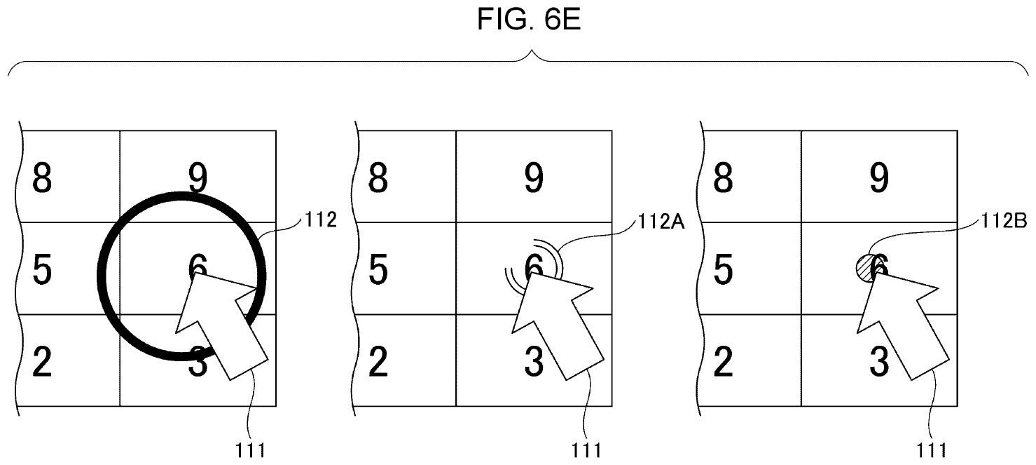

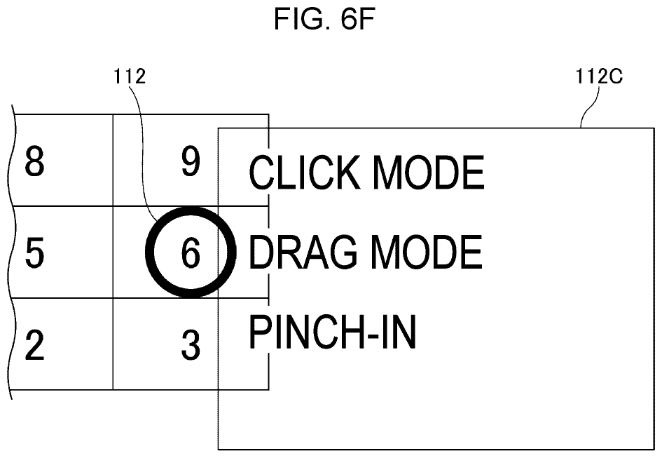

FIGS. 6A to 6F are diagrams showing examples of display of the display 110 of the non-contact input device 100. FIG. 6A and FIG. 6B show the display 110 and the operation surface 105A superimposed. The display of the display 110 is visible to the user through the operation surface 105A. FIGS. 6C to 6F show a portion of the image displayed on the display 110.

FIG. 6A shows the display of the display 110 in the standby mode. When the fingertip FT of the user is not near the operation surface 105A, messages such as “Touchless operation is available” and “Place your finger above the screen” are displayed, as shown in FIG. 6A. This allows the user to guide the fingertip FT toward the operation surface 105A even in a case of using the non-contact input device 100 for the first time, facilitating smooth subsequent use.

FIG. 6B shows an example of a message in the proximity mode. FIG. 6B displays the message “The pointer shrinks according to position accuracy” and “When the pointer is large, bring your finger closer to the pointer or hold your finger vertically”. When the user brings the fingertip FT close to the operation surface 105A, the display 110 shows the second pointer 112. The pointer is a graphic or a symbol that indicates the current input position on the screen (image) displayed on the display 110.

The second pointer 112 is a graphic that the input assistance application 150 causes the OS 140 to display. Furthermore, the input assistance application 150 hides the first pointer (mouse pointer) 111 provided by the OS. The second pointer 112 may be a circular or elliptical shape, other than the annular shape shown in FIG. 6B. The input assistance application 150 increases the radius of the second pointer 112 as the amount of fluctuation in the XY coordinates, which is a position accuracy metric, is larger, and decreases the radius of the second pointer 112 as the amount of fluctuation in the XY coordinates is smaller. In other words, the input assistance application 150 displays, on the display 110 via the OS 140, the second pointer 112 that has a larger radius as the amount of fluctuation in the XY coordinates is greater, and displays, on the display 110 via the OS 140, the second pointer 112 that has a smaller radius as the amount of fluctuation in the XY coordinates is smaller.

Here, with reference to FIG. 6C, the description is made to the more specific operation when the user brings the fingertip FT closer to the operation surface 105A in order to select the number 6 of the GUI button in the selection mode. In FIG. 6C, since the first pointer 111 is hidden, only the second pointer 112 is shown. In the selection mode, the circular second pointer 112 is displayed.

As shown on the left side of FIG. 6C, the input assistance application 150 causes the OS 140 to display the second pointer 112 that has a larger radius as the amount of fluctuation in the XY coordinates increases. For example, in a case where the fingertip FT is farther from the operation surface 105A, the amount of fluctuation in the XY coordinates is larger.

Furthermore, as shown on the right side of FIG. 6C, the input assistance application 150 causes the OS 140 to display the second pointer 112 that has a smaller radius as the amount of fluctuation in the XY coordinates is smaller. For example, in a case where the fingertip FT is closer to the operation surface 105A, the amount of fluctuation in the XY coordinates is smaller.

That is, when operating the number 6 of the GUI button, in a case where the fingertip FT is far from the operation surface 105A, the second pointer 112 with a larger radius is displayed, as shown on the left side of FIG. 6C. When the fingertip FT is brought closer to the operation surface 105A, the radius of the second pointer 112 is smaller, and the second pointer 112 with a smaller radius is displayed as shown on the right side of FIG. 6C. Thus, in a case where the fingertip FT is far from the operation surface 105A and the accuracy of the XY coordinates is low, the radius of the second pointer 112 is set large, and in a case where the fingertip FT is close to the operation surface 105A and the accuracy of the XY coordinates is high, the radius of the second pointer 112 is set small. In this way, the non-contact input device 100 can provide the user with intuitive feedback on position accuracy.

FIG. 6D shows the operation when, in the decision mode, the user brings the fingertip FT close to the operation surface 105A and keeps holding the fingertip FT in order to decide the operation input of the number 6 of the GUI button. A second pointer 112A changes the display color from the second pointer 112 shown in FIG. 6C. Therefore, in FIG. 6D, the second pointer 112A is shown with a double line. The input assistance application 150 intuitively indicates a change in the input mode by changing the circular shape of the second pointer 112 into the arc of the second pointer 112A. Furthermore, the input assistance application 150 can emphasize the change in the input mode by changing the second pointer from red (112) to yellow (112A). Note that the color of the second pointer is not limited to changing from red to yellow. The color of the second pointer (112, 112A) may be changeable via the settings screen described later. Alternatively, instead of the color, the brightness may be changed or both the color and the brightness may be changed.

FIG. 6D shows how the image changes over time, according to the arrows from the top left to the top right, then to the bottom left, and finally to the bottom right.

In the decision mode, the arc-shaped second pointer 112A is first displayed as shown in the upper left. When the fingertip FT is brought close to the operation surface 105A and kept holding, the arc extends as shown in the upper right. Furthermore, as shown in the lower left, the arc of the second pointer 112A extends. When a first predetermined time T1 has elapsed since the fingertip FT was stationary relative to the operation surface 105A, the second pointer 112A changes to an annular ring. The operation content is decided when the second pointer 112A changes to the annular ring. That is, the operation content is decided by continuously pointing the number 6 with the fingertip FT until the second pointer 112A changes to the annular ring. The non-contact input device 100 enables the user to perform a non-contact click operation instead of the operation of touching the operation surface 105A.

When the operation content is decided, the input assistance application 150 outputs a click event. Through the non-contact fingertip FT operation input, the input assistance application 150 issues the event same as that when a mouse is clicked. The input assistance application 150 outputs the XY coordinates of the fingertip FT to the OS 140 to output the click event. Alternatively, the click event output sound may be played back by the OS 140. This non-contact output of each of the XY coordinates and the click event corresponds to the operation of touching the GUI button 110A on the operation surface 105A.

When outputting a click event, the input assistance application 150 displays a second pointer 112B, which is a circular with a radius smaller than that of the annular ring, for a predetermined time (for example, approximately one to two seconds), as shown in the lower right of FIG. 6D.

The circular second pointer 112B is displayed at the XY coordinates (moving average) of the fingertip FT when an operation input is decided, for user confirmation. The second pointer 112B is, as an example, displayed for a predetermined time (approximately one to two seconds) and is hidden when the predetermined time has elapsed. The second pointer 112B may have a different display color from the second pointer 112 and 112A. The input assistance application 150 intuitively indicates that the operation input has been confirmed by changing the second pointer 112A to a small circle immediately after the center angle of the second pointer 112A (arc) reaches 360 degrees. Furthermore, changing the color can emphasize that the operation input has been confirmed. Alternatively, instead of the color, the brightness may be changed or both the color and the brightness may be changed.

FIGS. 6C and 6D show an example where the first pointer 111 of the OS 140 has been erased, but, as shown in FIG. 6E, both the first pointer 111 (mouse pointer) of the OS 140 and the second pointer 112 (non-contact input device pointer) generated by the input assistance application 150 may be displayed. In a case of displaying both the first pointer 111 and the second pointer 112, the input assistance application 150 continues to output the XY coordinates to the OS 140 in the selection mode and the decision mode described later. The first pointer 111 functions as a reticle indicating the position of the XY coordinates with high precision.

### <Display Of Function Menu>

FIG. 6F shows a function menu 112C. In the selection mode, in a case where the XY coordinates of the fingertip FT remain stationary for a predetermined time in the state where the fingertip FT is brought close to the operation surface 105A and the radius of the second pointer 112 is small as shown on the right side of FIG. 6C, the input assistance application 150 causes the OS 140 to display the function menu 112C. This predetermined time is an example of a third predetermined time. FIG. 6F shows, as an example, the function menu 112C that allows selection of a click mode, a drag mode, and a pinch-in.

### <Flowchart>

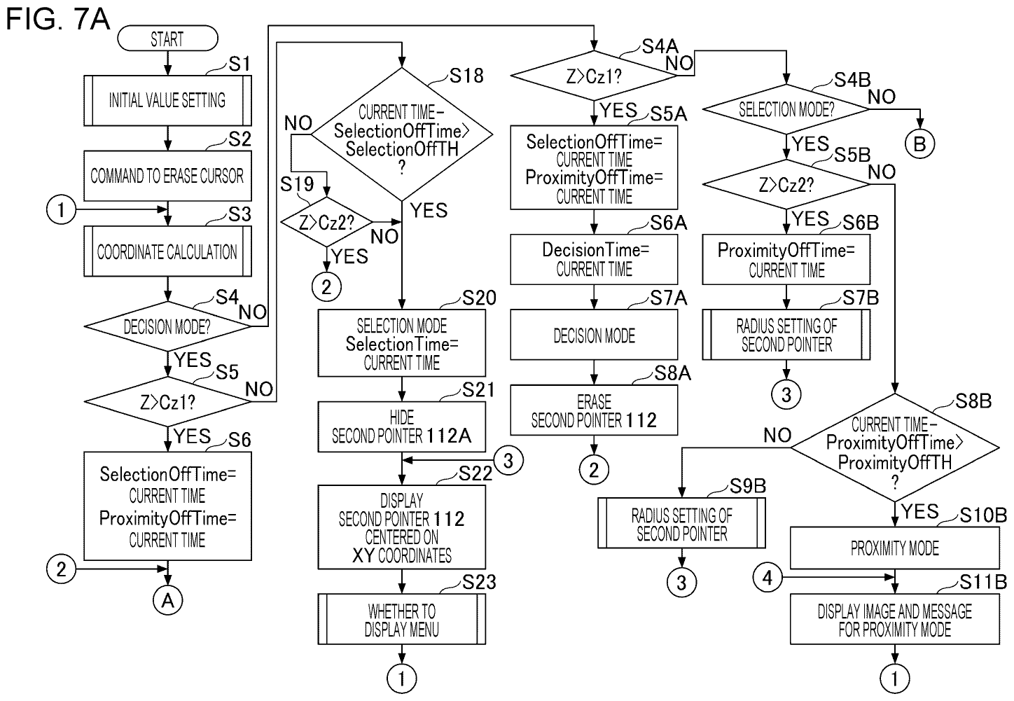

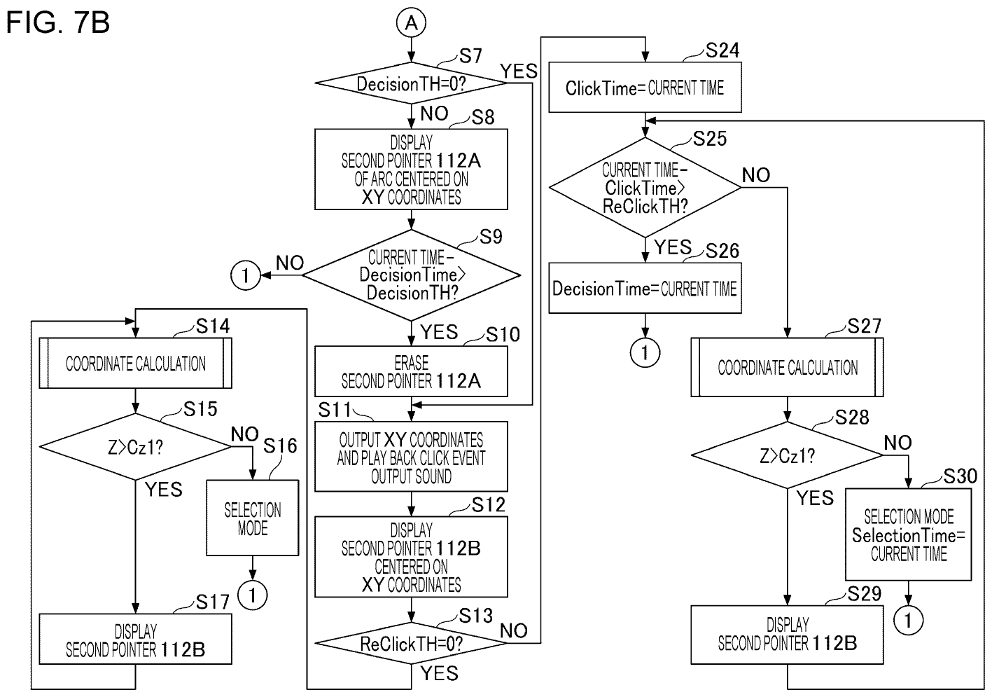

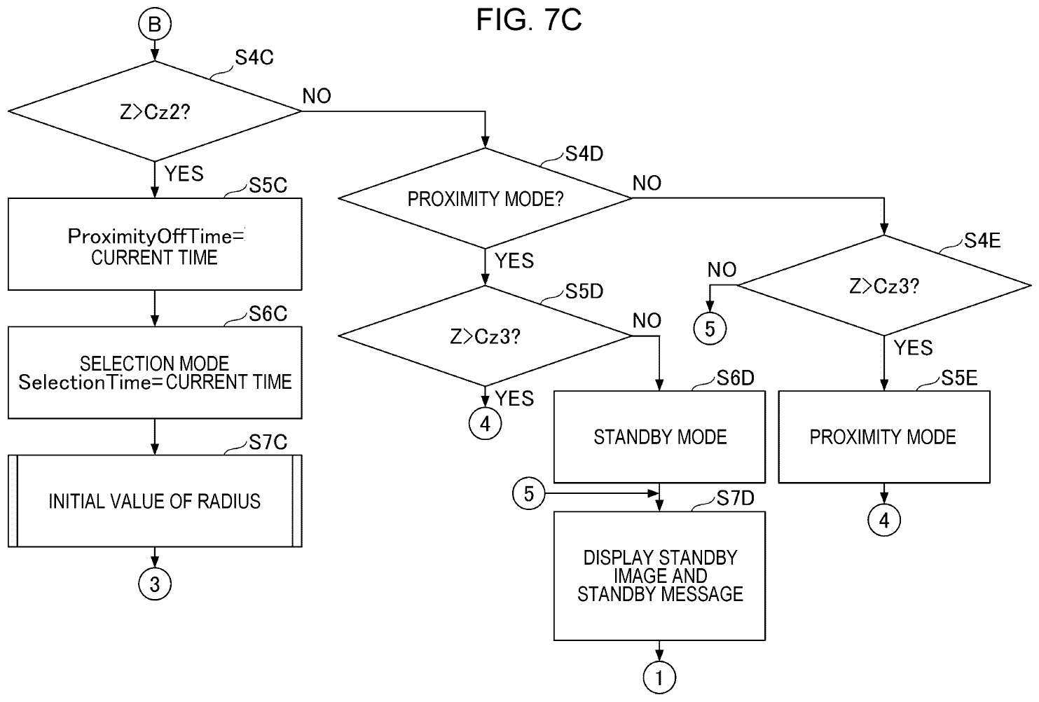

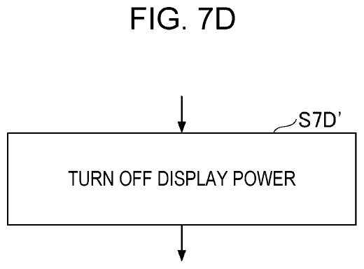

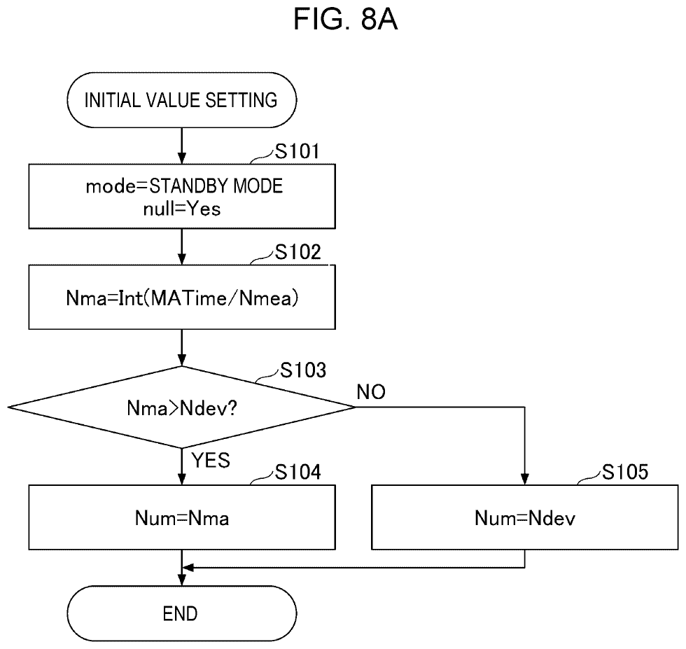

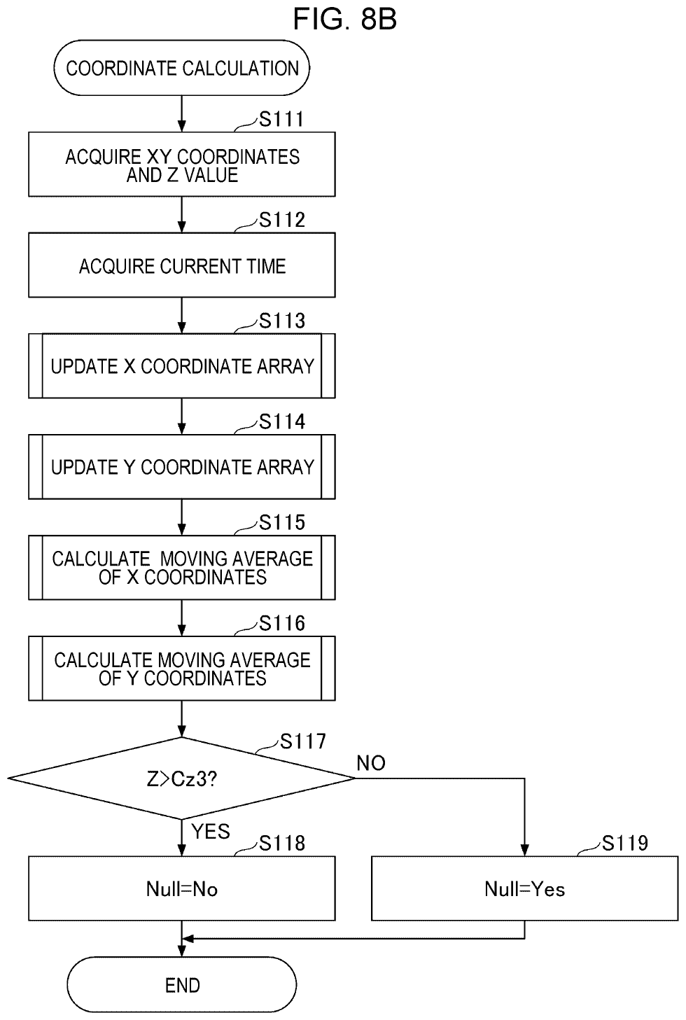

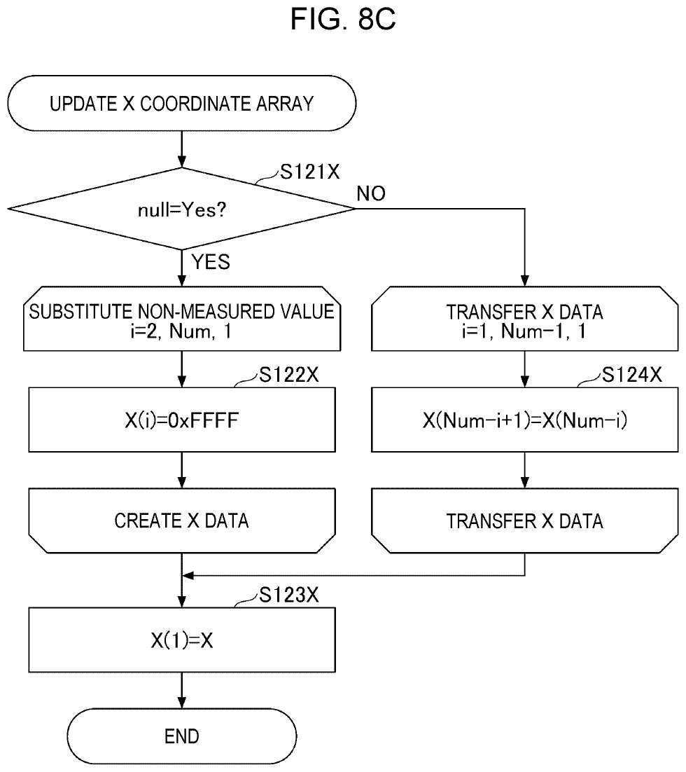

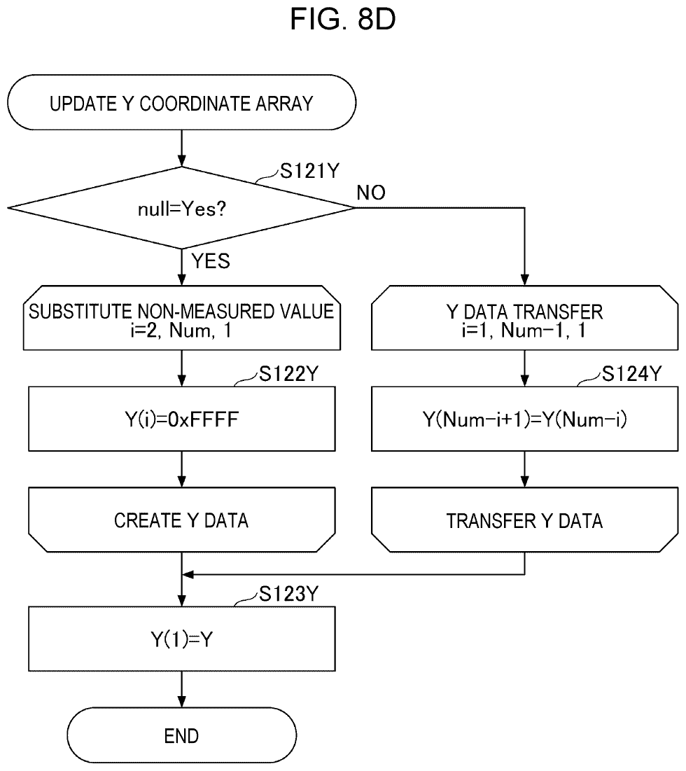

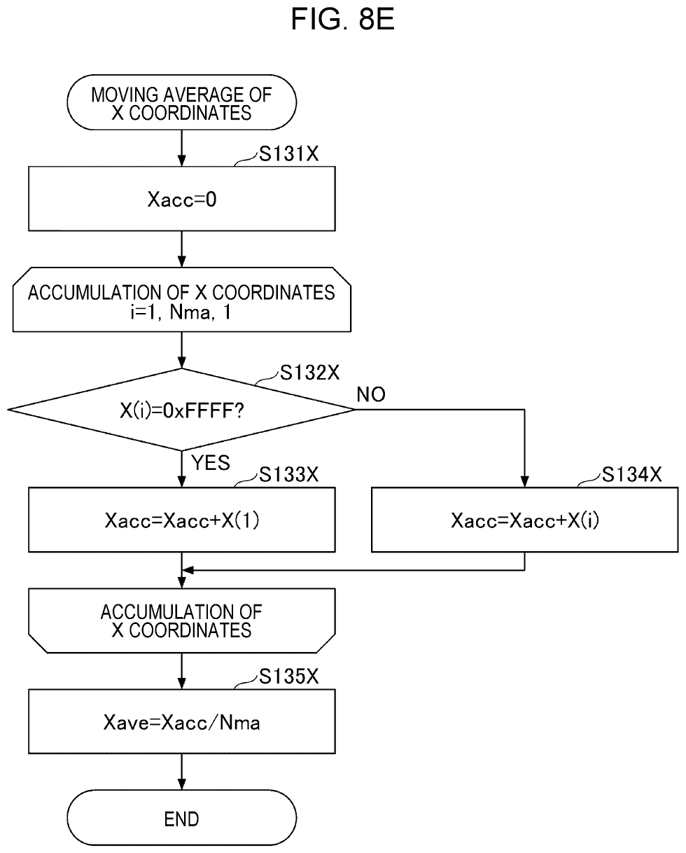

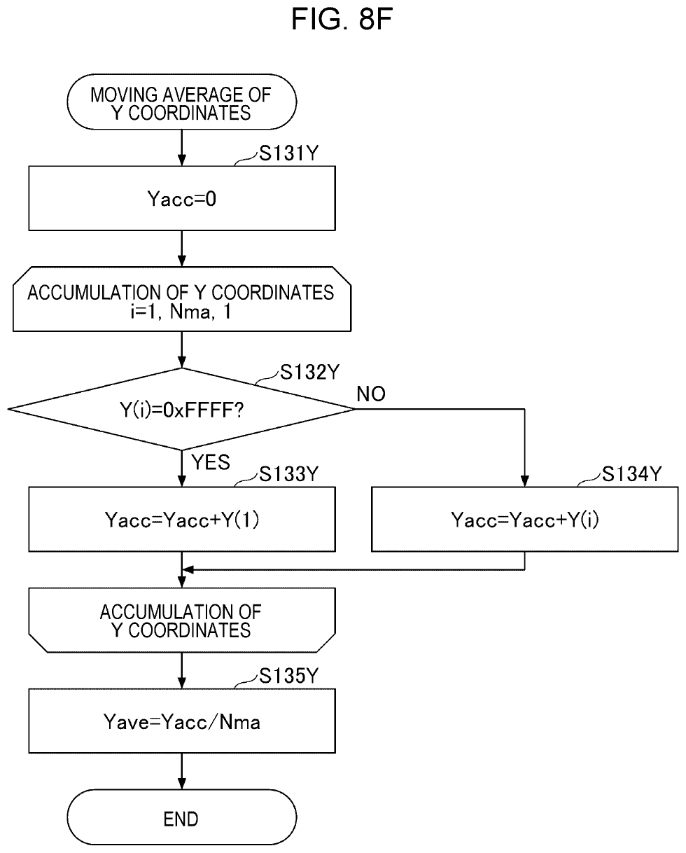

FIGS. 7A to 7C, FIGS. 8A to 8F, and FIGS. 9A to 9F are diagrams showing an example of the process executed by the input assistance application 150 of the non-contact input device 100. FIGS. 7A to 7C show an example of the main process, FIG. 7D shows an example of a modification of the process shown in FIG. 7C, and FIGS. 8A to 8F and FIGS. 9A to 9F show an example of the subroutine process.

The input assistance application 150, upon starting the process (see FIG. 7A), performs an initial value setting (step S1). Step S1 is a subroutine. Details thereof will be described later using FIG. 8A, but an initial value such as the number of pieces of data Nma for calculating the moving average is set.

The input assistance application 150 outputs a command to erase the first pointer 111 to the OS 140 (step S2). As a result, the first pointer 111 is erased from the display 110. Alternatively, the first pointer 111 (mouse pointer) may be displayed without performing the process of step S2 (see FIG. 6E). In this case, both the first pointer 111 and the second pointer 112 will be displayed. In this case, the input assistance application 150 continuously outputs the XY coordinates of the fingertip FT to the OS. Since the position of the first pointer 111 matches the center of the second pointer 112, the center is easy to identify even when the second pointer 112 is a large circle.

The input assistance application 150 calculates the XY coordinates of the fingertip FT (step S3). Step S3 is a subroutine. Details thereof will be described later, but the moving average of the XY coordinates of the fingertip FT is calculated using the XY coordinates, of the fingertip FT, calculated at a plurality of time points.

The input assistance application 150 determines whether the input assistance application 150 is in the decision mode (step S4). For ease of explanation, the description is made about the case where the input assistance application 150 is in the decision mode.

In a case where it is determined that the input assistance application 150 is in the decision mode (S4: YES), the input assistance application 150 determines whether the Z value is greater than Cz1 (step S5). The input assistance application 150 considers the distance from the operation surface 105A to the fingertip FT to be shorter than the first threshold value Z1 in a case where the Z value is greater than Cz1. The input assistance application 150 determines whether the fingertip FT is positioned in the decision region based on the Z value.

In a case where it is determined that the Z value is greater than Cz1 (S5: YES), the input assistance application 150 sets SelectionOffTime and ProximityOffTime to the current time (current time) (step S6). SelectionOffTime is updated at the time when the Z value is determined to be greater than Cz1. Therefore, SelectionOffTime indicates the last time at which the Z value was determined to be greater than Cz1. Furthermore, as described later, ProximityOffTime is updated when the Z value is determined to be greater than Cz2. Therefore, ProximityOffTime indicates the last time at which the Z value was determined to be greater than Cz2.

The input assistance application 150 determines whether DecisionTH is zero (S7). DecisionTH is a user-configurable value. If DecisionTH is zero, the arc cursor described later will not be displayed, and the input will be confirmed immediately when the decision mode is set. On the other hand, if DecisionTH is non-zero, the arc cursor described later is displayed, and then the input is confirmed.

In a case where it is determined that DecisionTH is not zero (S7: No), the input assistance application 150 outputs, to the OS 140, a command to display the arc-shaped second pointer 112A at the XY coordinates (moving average: Xave, Yave) calculated in step S3 (step S8). The command output to the OS 140 in step S8 is a command to display an arc with a radius of a predetermined value (fixed value) centered on the XY coordinates (moving average). The arc is an arc in which the moving end extends clockwise relative to the fixed end, the fixed end being positioned at the 12 o'clock position on a clock face, and the moving end extending clockwise from 12 o'clock. The input assistance application 150 calculates the arc angle between the fixed end and the moving end, as an example, using the following equation (1):

$$Arc angle = 360 degrees \times ( current time - Decision Time ) / Decision TH \qquad ( 1 )$$

where, DecisionTime is a time when arc drawing began, and DecisionTH is a time required from the start of the arc drawing to the output of the click event. A click event is an event that is performed in a case where the operation content is decided according to the operation input through the fingertip FT. The operation content is decided by the second pointer 112A changing from an arc to an annular ring. When the operation content is decided, the input assistance application 150 outputs a click event. The user can decide the operation content by bringing the fingertip FT close to the operation surface 105A in the decision region and holding the fingertip FT until the second pointer 112A extends and changes to an annular ring.

The input assistance application 150 determines whether the condition that current time-DecisionTime>DecisionTH is satisfied (step S9). That is, the input assistance application 150 determines whether the elapsed time since the time (DecisionTime) of transition to the decision mode has exceeded DecisionTH. This is for determining whether the operation content has been decided, and for determining whether to output the click event that is performed in a case where the operation content is decided. The elapsed time since the time (DecisionTime) of transition to the decision mode is an example of a first predetermined time.

In a case where it is determined that the condition that current time-DecisionTime>DecisionTH is not satisfied (S9: NO), the input assistance application 150 returns the flow to step S3. By repeatedly performing the process of steps S3 to S8, the arc extends.

In a case where it is determined that the condition that current time-Decision Time>DecisionTH is satisfied (S9: YES), the input assistance application 150 advances the process to output a click event. When the condition that current time-Decision Time>DecisionTH is established, the arc cursor changes to an annular ring.

The input assistance application 150 erases the second pointer 112A (step S10).

The input assistance application 150 outputs the XY coordinates (moving average) calculated in step S3 to the OS 140, and then outputs the click event to the OS 140. Furthermore, the input assistance application 150 causes the OS 140 to play back the click event output sound (step S11). This causes the click event output sound to be output from the speaker. Furthermore, when a click event is issued in a case where the XY coordinates overlap with the GUI button 110A of the application program 160, the application program 160 executes the process indicated by the GUI button 110A.

In a case where it is determined that DecisionTH is zero (S7: Yes), the input assistance application 150 executes the process described in step S11. In other words, in a case where it is determined that DecisionTH is zero (S7: Yes) and in a case where it is determined that the condition that current time-DecisionTime>DecisionTH is satisfied (S9: YES), the input assistance application 150 outputs the XY coordinates and the click event to the OS 140, and causes the OS 140 to play back the click event output sound.

The input assistance application 150 causes the OS 140 to display the second pointer 112B, for a predetermined time, centered on the XY coordinates (moving average) calculated in step S3 (step S12).

The center of the second pointer 112B is the XY coordinates (moving average) calculated in step S3. The predetermined time is approximately one to two seconds as an example, and after the predetermined time has elapsed, the second pointer 112B is hidden.

The input assistance application 150 determines whether the condition that ReClickTH=0 is satisfied (step S13). ReClickTH is a time (click re-output time) until the second pointer 112A begins to be displayed again in a case where the fingertip FT remains positioned in the decision region after the click event is output. The user of the non-contact input device 100 can set ReClickTH for the input assistance application 150 through the settings screen displayed on the display 110.

In a case where it is determined that the condition that ReClickTH=0 is satisfied (S13: YES), the input assistance application 150 calculates the XY coordinates of the fingertip FT (step S14). Step S14 is a subroutine, similar to step S3. Details thereof will be described later, but the moving average of the XY coordinates of the fingertip FT is calculated using the XY coordinates, of the fingertip FT, calculated at a plurality of time points.

The input assistance application 150 determines whether the Z value is greater than Cz1 (step S15). The input assistance application 150 determines whether the fingertip FT remains in the decision region after the operation content is decided.

In a case where it is determined that the Z value is not greater than Cz1 (S15: NO), the input assistance application 150 sets the mode to the selection mode (step S16). Then, the flow returns to step S3. That the Z value ΔAD is not greater than Cz1 means that the fingertip FT has moved from the decision region to the selection region, the proximity region, or the like. In a case where the fingertip FT moves from the decision region to the selection region, proximity region, or the like, the process in step S14 is provided to enable re-input.

In a case where it is determined in step S15 that the Z value is greater than Cz1 (S15: YES), the input assistance application 150 causes the OS 140 to display the second pointer 112B at the XY coordinates (moving average) calculated in step S14 (step S17). The size of the circular second pointer 112B is a predetermined value.

In a case where the click re-output time (ReClickTH) is set to zero, the input assistance application 150 continues to display the second pointer 112B at the position of the XY coordinates of the fingertip FT without re-outputting the click event, unless the mode transitions from the decision mode to another mode.

After completing the process in step S17, the input assistance application 150 returns the flow to S14. In a case where YES is determined in step S7 or YES is determined in step S9, the operation content is decided, and after displaying the second pointer 112B in step S12, the fingertip FT remains in the decision region, the input assistance application 150 displays the second pointer 112B in step S17 and then returns the flow to step S14. In other words, while updating the position of the second pointer 112B, the input assistance application 150 continues to display the second pointer 112B. To decide the next operation content after the operation content was decided, the fingertip FT may be moved outside the decision region.

### <S5: NO>

Furthermore, in a case where it is determined in step S5 that the Z value is not greater than Cz1 (S5: NO), the input assistance application 150 determines whether the condition that current time-SelectionOffTime>SelectionOffTH is satisfied (step S18). That is, when the fingertip FT is continuously positioned outside the decision region, the input assistance application 150 determines whether the elapsed time since the time (SelectionOffTime) at which the fingertip FT was last determined to be in the decision region has exceeded SelectionOffTH. This elapsed time is an example of a fourth predetermined time.

SelectionOffTH is a time it takes to transition from the decision mode to the selection mode in a case where the fingertip FT is moved to the selection region. The user of the non-contact input device 100 can set SelectionOffTH for the input assistance application 150 through the settings screen displayed on the display 110. The time at which the fingertip FT was last determined to be positioned in the decision region is the most recent time at which the fingertip FT was determined to be positioned in the decision region.

In a case where it is determined that the condition that current time-SelectionOffTime>SelectionOffTH is not satisfied (S18: NO), the input assistance application 150 determines whether the Z value is greater than Cz2 (step S19). The input assistance application 150 considers the fingertip FT to remain within the first region in a case where the Z value is greater than Cz2. When Z is greater than Cz2 (S19: YES), the flow returns to step S7. As a result, operation in the decision mode continues. The moving average is not used for the Z value, and the value smaller than the actual value may be measured due to noise. In other words, even in a case where the fingertip FT is positioned in the decision region, the condition that Z>Cz1 may not be satisfied (S5: NO). Therefore, even when the Z value is not greater than Cz1, if the Z value is greater than Cz2, the drawing of the second pointer 112A continues for a certain period of time (during SelectionOffTH). On the other hand, if the Z value is not greater than Cz2 (S19: NO), the input assistance application 150 sets the mode to the selection mode, and sets the current time to SelectionTime (step S20). If the Z value is not greater than Cz2, the fingertip FT is considered to be outside the decision region.

Additionally, in a case where it is determined that the condition that current time-SelectionOffTime>SelectionOffTH is satisfied (S18: YES), the input assistance application 150 sets the mode of the input assistance application 150 to the selection mode and sets the SelectionTime to the current time (step S20). In a case where the state where the Z value is not greater than Cz1 (step S5) continues longer than SelectionOffTH, the fingertip FT is considered to be outside the decision region.

The input assistance application 150 causes the OS 140 to hide the second pointer 112A (step S21).

The input assistance application 150 causes the OS 140 to display the second pointer 112 (step S22). The second pointer 112 is a second pointer for the selection mode shown in FIG. 6C. The input assistance application 150 causes the OS 140 to hide the second pointer 112A before causing the OS 140 to display the second pointer 112. The center of the second pointer 112 is the XY coordinates (moving average) of the fingertip FT, and the radius of the second pointer 112 is a radius corresponding to the amount of fluctuation in the XY coordinates. The input assistance application 150 outputs the position of the second pointer 112 corresponding to the XY coordinates (moving average) of the fingertip FT to the OS 140 when causing the OS 140 to display the second pointer 112 in step S22. Furthermore, the input assistance application 150 sets the size of the second pointer 112 to a size corresponding to the amount of fluctuation in the XY coordinates.

The input assistance application 150 executes a process for determining whether to display the function menu (step S23). The process for determining whether to display the function menu is a subroutine process, so that the details thereof will be described later. After completing the process in step S23, the input assistance application 150 returns the flow to step S3.

### <S13: NO>

In a case where it is determined in step S13 that the condition that ReClickTH=0 is not satisfied (S13: NO), the input assistance application 150 sets ClickTime to the current time (step S24). ClickTime is a time when the click event is output.

The input assistance application 150 determines whether the condition that current time−ClickTime>ReClickTH is satisfied (step S25).

In a case where the condition that current time−ClickTime>ReClickTH is satisfied (S25: YES), the input assistance application 150 sets Decision Time to the current time (step S26). Then, the flow returns to step S3. Therefore, the DecisionTime is the time when returning to step S3. When the fingertip FT remains in the decision region, a gradually lengthening arc is drawn again. The time from when a click event is output until the drawing of the second pointer 112A (arc) begins again is the sum of the “predetermined time” in step S12 and ReClickTH. It takes the time of Decision TimeTH from the start of drawing the second pointer 112A (arc) until the second pointer 112A changes to an annular ring. The click event is output each time the sum of the “predetermined time” in step S12, ReClickTH, and DecisionTimeTH elapses. In other words, the sum of the “predetermined time” in step S12, ReClickTH, and DecisionTimeTH is the second predetermined time.

In a case where it is determined in step S25 that the condition that current time−ClickTime>ReClickTH is not satisfied (S25: NO), the input assistance application 150 calculates the XY coordinates of the fingertip FT (step S27). Step S27 is a subroutine, similar to step S3. The details thereof will be described later, but the moving average of the XY coordinates of the fingertip FT is calculated using the XY coordinates, of the fingertip FT, calculated at a plurality of time points.

The input assistance application 150 determines whether the Z value is greater than Cz1 (step S28). This is for determining whether the fingertip FT is positioned in the decision region.

In a case where it is determined that the Z value is greater than Cz1 (S28: YES), the input assistance application 150 displays the second pointer 112B at a position centered on the XY coordinates of the fingertip FT (step S29). The input assistance application 150 causes the OS 140 to display the second pointer 112B until the click re-output timeout (ReClickTH) elapses, in a case where the mode remains in the decision mode.

In a case where it is determined in step S27 that the Z value is not greater than Cz1 (S28: NO), the input assistance application 150 sets the mode of the input assistance application 150 to the selection mode and sets the current time to SelectionTime (step S30). When the fingertip FT moves from the decision region to the selection region, the mode immediately transitions to the selection mode. A user who desires to perform the next operation input as quickly as possible can switch to the selection mode by slightly moving the fingertip FT off the operation surface 105A. After completing the process in step S30, the input assistance application 150 returns the flow to step S3.

### <S4: NO>

Furthermore, in a case where it is determined in step S4 that the decision mode is not set (S4: NO), the input assistance application 150 determines whether the Z value is greater than Cz1 (step S4A). That is, the input assistance application 150 determines whether the fingertip FT is positioned in the decision region. When the Z value is greater than Cz1, the fingertip FT is positioned in the decision region.

In a case where it is determined that the Z value is greater than Cz1 (S4A: YES), the input assistance application 150 sets SelectionOffTime and ProximityOffTime to the current time (current time) (step S5A). SelectionOffTime is updated at the time at which the Z value is determined to be greater than Cz1, so that SelectionOffTime indicates the last time at which the Z value was determined to be greater than Cz1. Furthermore, as described later, ProximityOffTime is updated when the Z value is determined to be greater than Cz2. Therefore, ProximityOffTime indicates the last time at which the Z value was determined to be greater than Cz2.

The input assistance application 150 sets DecisionTime to the current time (step S6A). The input assistance application 150 outputs a click event when the time spent in the decision mode reaches DecisionTH. After it is determined in step S4 that the mode is not the decision mode, it is determined in step S4A that the Z value is greater than Cz1, so that the time at which step S6A is executed is a time at which the decision mode is set. In other words, DecisionTime set in step S6A is the time at which the decision mode is set.

The input assistance application 150 sets the mode of the input assistance application 150 to the decision mode (step S7A). Furthermore, the input assistance application 150 erases the second pointer 112 for the selection mode (step S8A). After completing the process in step S8A, the flow proceeds to step S7.

The flow proceeds to step S4: NO and S4A: YES in a case where the fingertip FT enters the decision region from outside the decision region. Thus, in a case where the fingertip FT approaches the operation surface 105A, the mode immediately transitions to the decision mode. On the other hand, in a case where the fingertip FT moves away from the operation surface 105A, the mode will not be changed immediately. As mentioned earlier, in a case where the Z value is smaller (in a case where the state in which the fingertip FT moves away from the operation surface 105A is measured), the operation is stabilized by not immediately changing modes. On the other hand, in a case where the moving average is not used for the Z value and the fingertip FT approaches the operation surface 105A, the rapid operation is achieved by immediately transitioning to the decision mode. Note that when the decision mode is set due to the influence of noise, the fingertip FT is not in the decision region but is located near the decision region (in the selection region). Therefore, the user does not perceive the state as a malfunction. This can simultaneously prevent both a decline in reaction speed and input errors.

### <S4A: NO>

Furthermore, in a case where it is determined in step S4A that the Z value is not greater than Cz1 (S4A: NO), the input assistance application 150 determines whether the input assistance application 150 is in the selection mode (step S4B).

In the selection mode, the input assistance application 150 determines whether the Z value is greater than Cz2 (step S5B). That is, the input assistance application 150 determines whether the fingertip FT is positioned in the selection region.

In a case where it is determined that the Z value is greater than Cz2 (S5B: YES), the input assistance application 150 sets ProximityOffTime to the current time (step S6B). ProximityOffTime is a time at which the fingertip FT was last determined to be positioned in the selection region when the fingertip FT is continuously positioned in the selection region. When the fingertip FT is positioned in the selection region, ProximityOffTime is updated, so that ProximityOffTime represents the latest time at which the fingertip FT is determined to be positioned in the selection region.

The input assistance application 150 performs a second pointer radius setting process that sets the radius of the second pointer 112 according to the amount of fluctuation in the XY coordinates (step S7B). The second pointer radius setting process is a subroutine process, so that the details thereof will be described later, but in the selection mode, the radius of the second pointer 112 (see FIG. 6C) is set according to the amount of fluctuation in the XY coordinates. After completing the process in step S7B, the input assistance application 150 advances the flow to step S21 and causes the OS 140 to display the second pointer 112.

### <S5B: NO>

In a case where it is determined in step S5B that the Z value is not greater than Cz2 (S5B: NO), the input assistance application 150 determines whether the condition that current time−ProximityOffTime>ProximityOffTH is satisfied (step S8B). That is, when the fingertip FT is continuously positioned in the selection region, the input assistance application 150 determines whether the elapsed time since the time (ProximityOffTime) at which the fingertip FT was last determined to be in the selection region has exceeded ProximityOffTH. ProximityOffTH is the time required to transition from the selection mode to the proximity mode. The user of the non-contact input device 100 can set ProximityOffTH for the input assistance application 150 through the settings screen displayed on the display 110.

In a case where it is determined that the condition that current time−ProximityOffTime>ProximityOffTH is not satisfied (S8B: NO), the input assistance application 150 executes the second pointer radius setting process of setting the radius of the second pointer 112 according to the amount of fluctuation in the XY coordinates (step S9B). The radius setting process for the second pointer is a subroutine process, so that the details thereof will be described later, but in the selection mode, the radius of the second pointer 112 (see FIG. 6C) is set according to the amount of fluctuation in the XY coordinates. After completing the process in step S9B, the input assistance application 150 advances the flow to step S21 and causes the OS 140 to display the second pointer 112. The moving average is not used for the Z value, and the value smaller than the actual value may be measured due to noise. However, the state in which the actual position of the fingertip FT is located in the selection region, but the condition that Z>Cz2 is not satisfied is resolved in a time shorter than ProximityOffTH. Therefore, even when a small Z value is measured due to noise while the second pointer 112 is being displayed, the display of the second pointer 112 continues. On the other hand, even when the fingertip FT is actually moved to the proximity region, the display of the second pointer 112 continues for a while. Most users do not perceive a delay in response even if it takes longer for the second pointer 112 to disappear. Therefore, the process from S8B: NO to S9B can stabilize movement without reducing sensory reaction speed.

In a case where it is determined in step S8B that the condition that current time−ProximityOffTime>ProximityOffTH is satisfied (S8B: YES), the input assistance application 150 sets the mode of the input assistance application 150 to the proximity mode (step S10B).

The input assistance application 150 causes the OS 140 to display an image and a message for the proximity mode (see FIG. 6B) (step S11B). As a result, as shown in FIG. 6B, the image and the message for the proximity mode are displayed on the display 110. After completing the process in step S11B, the input assistance application 150 advances the flow to step S3.

### <S4B: NO>

Furthermore, in a case where it is determined in step S4B that the input assistance application 150 is not in the selection mode (S4B: NO), the input assistance application 150 determines whether the Z value is greater than Cz2 (step S4C). That is, the input assistance application 150 determines whether the fingertip FT has re-entered the selection region.

In a case where it is determined that the Z value is greater than Cz2 (S4C: YES), the input assistance application 150 sets ProximityOffTime to the current time (step S5C). As mentioned earlier, when the condition that Z>Cz1 (S5 or S4A) is YES, or when the condition that Z>Cz2 (S5B or S4C) is YES, ProximityOffTime is updated to the current time. Therefore, the last time at which Z was greater than Cz2 is stored as ProximityOffTime.

The input assistance application 150 sets the mode of the input assistance application 150 to the selection mode and sets the current time to SelectionTime (step S6C).

The input assistance application 150 performs the process of setting the radius of the second pointer 112 to an initial value (step S7C). The process of setting the radius of the second pointer 112 to the initial value is a subroutine process, so that the details thereof will be described later. This process sets the radius of the second pointer 112 to the initial value, not to a radius corresponding to the amount of fluctuation in the XY coordinates. After completing the process in step S7C, the input assistance application 150 advances the flow to step S21 and causes the OS 140 to display the second pointer 112. Note that the fingertip FT is actually located in the proximity region, but the Z value is measured larger than it actually is due to noise, and the selection mode may be set. However, since the selection mode is set when the fingertip FT is located near to some extent, most users do not recognize the state as a malfunction. Conversely, in a case where the fingertip FT is in a distant position (standby region), the selection mode is not set even when noise at the normally existing level is present.

### <S4C: NO>

When it is determined in step S4C that the Z value is not greater than Cz2 (S4C: NO), the input assistance application 150 determines whether the input assistance application 150 is in the proximity mode (step S4D).

In a case where it is determined that the input assistance application 150 is in the proximity mode (S4D: YES), the input assistance application 150 determines whether the Z value is greater than Cz3 (step S5D). The input assistance application 150 considers the distance from the operation surface 105A to the fingertip FT to be shorter than the third threshold value Z3 in a case where the Z value is greater than Cz2.

In a case where it is determined that the Z value is greater than Cz3 (S5D: YES), the input assistance application 150 advances the flow to step S11B. As a result, in step S11B, as shown in FIG. 6B, the image and the message for the proximity mode are displayed on the display 110.

### <S5D: NO>

In a case where it is determined in step SSD that the Z value is not greater than Cz3 (S5D: NO), the input assistance application 150 sets the mode of the input assistance application 150 to the standby mode (step S6D). The input assistance application 150 considers the distance from the operation surface 105A to the fingertip FT to be longer than the third threshold value Z3 in a case where the Z value is not greater than Cz3.

The input assistance application 150 causes the OS 140 to display the image and the message for the standby mode (step S7D). As a result, the image and the message for the standby mode are displayed on the display 110. After completing the process in step S7D, the input assistance application 150 advances the flow to step S3. Note that in the standby mode, the display power may be turned off (S7D′ in FIG. 7D).

### <S4D: NO>

In a case where it is determined in step S4D that the input assistance application 150 is not in the proximity mode (S4D: NO), the input assistance application 150 determines whether the Z value is greater than Cz3 (step S4E). The input assistance application 150 determines whether the fingertip FT has re-entered the proximity region.

In a case where it is determined that the Z value is greater than Cz3 (S4E: YES), the input assistance application 150 sets the mode of the input assistance application 150 to the proximity mode (step S5E). The input assistance application 150 proceeds to step S11B and displays the image and the message for the proximity mode.

Furthermore, in a case where it is determined in step S4E that the Z value is not greater than Cz3 (S4E: NO), the input assistance application 150 advances the flow to step S7D. In this case, since the input assistance application 150 is in the standby mode, the image and the message for the standby mode are displayed on the display 110 in step S7D.

This concludes the sequence of main flows. The input assistance application 150 repeatedly executes the main flow. Next, each subroutine will be described.

### <FIG. 8A: Initial Value Settings>

The input assistance application 150 sets the mode of the input assistance application 150 to the standby mode and sets the flag null to YES (step S101).

The input assistance application 150 sets Nma to a predetermined integer (step S102). Nma is a calculated value representing the number of pieces of data used when calculating the moving average, calculated as Nma=int (MATime/Nmea). The predetermined integer is obtained as int (MATime/Nmea). int (MATime/Nmea) represents the integer obtained by truncating the decimal portion of MATime/Nmea. MATime is a time used for the moving average (the time from the start period to the end period), and Nmea is a measurement interval. That is, Nma=int (MATime/Nmea). Additionally, the user of the non-contact input device 100 can set MATime for the input assistance application 150 through the settings screen displayed on the display 110.

The input assistance application 150 compares Nma with Ndev to determine which is larger (step S103). Ndev is the number of pieces of data used when calculating position accuracy metrics.

The input assistance application 150 sets the larger one of Nma and Ndev as the number Num in the array (steps S104, S105). In other words, the larger one of the two values: the number of pieces of data required to calculate the moving average; and the number of pieces of data required to calculate the position accuracy metric is set to the number Num of the array. Since the number of elements in the array is determined, the array may be declared at this stage. After completing the process in step S104, the input assistance application 150 terminates the initial value setting subroutine.

### <FIG. 8B: Coordinate Calculation>

The input assistance application 150 acquires the XY coordinates and the Z value from the input sensor circuit 125A (step S111).

The input assistance application 150 obtains the current time (current time) from the OS 140 (step S112). The “current time” used in the aforementioned main loop employs the value acquired in step S112.

The input assistance application 150 updates the array of the X coordinates (step S113). Step S113 is a subroutine process, and the details thereof will be described later. In step S113, the input assistance application 150 removes the oldest value from the array used to calculate the moving average of the X coordinate and the position accuracy metric, and adds the most recent value.

The input assistance application 150 updates the array of the Y coordinates (step S114). Step S113 is a subroutine process, and the details thereof will be described later. In step S114, the input assistance application 150 removes the oldest value from the array used to calculate the moving average of the Y coordinate and the position accuracy metric, and adds the most recent value.

The input assistance application 150 calculates a moving average from the array of the X coordinates updated in step S113 (step S115).

The input assistance application 150 calculates the moving average of the array of the Y coordinates updated in step S114 (step S116).

The input assistance application 150 determines whether the Z value acquired in step S111 is greater than Cz3 (step S117). In a case where the Z value is not greater than Cz3, the Z value falls within the standby region. Since the reliability of the latest XY coordinates acquired in step S111 and the XY coordinates acquired in step S111 prior to that is low, and these coordinate values are not suitable for calculating the moving average of the XY coordinates, the process in step S117 is provided.

In a case where it is determined that the Z value acquired in step S111 is greater than Cz3 (S117: YES), the input assistance application 150 sets the flag null to NO (step S118). The latest XY coordinates are suitable for calculating the moving average of XY coordinates and the position accuracy metric, so that the flag null is set to NO.

In a case where it is determined that the Z value acquired in step S111 is not greater than Cz3 (S117: NO), the input assistance application 150 sets the flag null to YES (step S119). The latest XY coordinates are not suitable for calculating the moving average of the XY coordinates, so that the flag null is set to YES.

This concludes the coordinate calculation subroutine.

### <FIG. 8C: Update Of X Coordinate Array>

FIG. 8C shows the details of the subroutine process of updating the array of the X coordinate in step S113 of FIG. 8B. In the following description, a plurality of the X coordinates acquired at a plurality of time points is distinguished as X(i). The times at which a plurality of the X coordinates X(i) is acquired are mutually different, and are a plurality of the X coordinates continuously acquired by the non-contact input device 100 at a predetermined sampling period. i=1 to Num, and X(1) is the latest X coordinate.

The input assistance application 150 determines whether the flag null is YES (step S121X). This is for determining whether the latest X coordinate is appropriate.

In a case where it is determined that the flag null is YES (S121X: YES), the input assistance application 150 performs the subroutine process that substitutes the non-measured value into X(i) to create the X coordinate.

The input assistance application 150 selects the (Num-1) X coordinates (X(2) to X(Num)) one by one where i ranges from 2 to Num, and substitutes the non-measured value (step S122X). The non-measured value is a value not obtained through measurement, and is a dummy value. Here, 0xFFFF is used as an example of a non-measured value. After completing the subroutine process including step S122X, the input assistance application 150 advances the flow to step S123X. Note that the non-measured value is only required to be a value that is not measured, and may be a value other than 0xFFFF.

The input assistance application 150 substitutes the latest X coordinate to X(1) (step S123X). In this manner, the input assistance application 150 updates the Num X coordinates X(1) to X(Num).

Additionally, in a case where it is determined that the flag null is NO (S121X: NO), the input assistance application 150 selects the (Num-1) X coordinates (X(1) to X(Num-1)) one by one, where i ranges from one to Num-1, increments the i number one by one, and moves to the X coordinate (X(2) to X(Num)) (step S124X).

After completing the process in step S124X, the input assistance application 150 advances the flow to step S123X. By adding the X coordinate X(1) to the X coordinates (X(2) to X(Num)) acquired in step S124X, the input assistance application 150 updates the array of the X coordinates X(1) to X(Num).

### <FIG. 8D: Acquisition Of Latest Num Y Coordinates>

FIG. 8D shows the details of the subroutine process of updating the Y coordinate array in step S114 of FIG. 8B. In the following description, a plurality of the Y coordinates is distinguished as Y(i). The times at which a plurality of the Y coordinates Y(i) is acquired are mutually different, and are a plurality of the Y coordinates continuously acquired by the non-contact input device 100 at a predetermined sampling period. The times at which a plurality of the Y coordinates Y(i) is acquired are each equal to the times at which a plurality of the X coordinates X(i) is acquired. i=1 to Num, and Y(1) is the latest Y coordinate.

The process in steps S121Y to S124Y shown in FIG. 8D is a process that is performed by the input assistance application 150 for the Y coordinate Y(i), and that replaces the process in steps S121X to S124X for the X coordinate X(i) shown in FIG. 8C with the process for the Y coordinate Y(i). Therefore, the description of FIG. 8D is omitted here. Alternatively, instead of the process of S121X to S123X and S121Y to S123Y, the oldest value in the array may be replaced with the latest value. In this case, there is no need to copy respective elements in the array. However, an index that identifies the element containing the oldest value and an index that identifies the element containing the most recent value are required. Additionally, the loop process for calculating the moving average and the amount of fluctuation, as described later, is required to be modified.

### <FIG. 8E: Moving Average Of X Coordinates>

FIG. 8E shows the details of the subroutine process of calculating the moving average of the X coordinate in step S115 of FIG. 8B.

The input assistance application 150 resets the accumulation value Xacc of the X coordinate to 0 (step S131X).

The input assistance application 150 executes the process of steps S132X, 133X, and 134X included in the subroutine that performs X coordinate accumulation. This subroutine accumulates X(i) as i increases one by one from 1 to Nma.

The input assistance application 150 determines whether X(i) is 0xFFFF (step S132X). 0xFFFF indicates that there is no measured Z value to use for calculating the X coordinate.

In a case where it is determined that X(i) is 0xFFFF (S132X: YES), the input assistance application 150 updates the accumulation value Xacc to Xacc+X(1) (step S133X). That is, in a case where dummy data is stored in X(i), the latest X coordinate (X(1)) is used to calculate the accumulation value. Therefore, the calculation of Xacc=Xacc+X(1) is carried out.

Furthermore, in a case where it is determined in step S132X that X(i) is not 0xFFFF (S132X: NO), the input assistance application 150 updates the accumulation value Xacc to Xacc+X(i) (step S134X). That is, the previously measured X coordinates (X(i)) are sequentially accumulated. Therefore, the calculation of Xacc=Xacc+X(i) is carried out.

When the process of steps S132X, 133X, and 134X is repeated for i of X(i) from 1 to Nma, the input assistance application 150 completes the process of the subroutine that accumulates the X coordinate, and advances the flow to step S135X.

The input assistance application 150 calculates the moving average of the X coordinate by dividing the accumulation value Xacc by Nma (step S135X). That is, the moving average of the X coordinate, Xave=Xacc/Nma.

### <FIG. 8F: Moving Average Of Y Coordinates>

FIG. 8F shows the details of the subroutine process of calculating the moving average of the Y coordinate in step S116 of FIG. 8B.

The process in steps S131Y to S135Y shown in FIG. 8F is a process that is performed by the input assistance application 150 for the Y coordinate Y(i), and that replaces the process in steps S131X to S135X for the X coordinate X(i) shown in FIG. 8E with the process for the Y coordinate Y(i). Therefore, the description of FIG. 8F is omitted here.

### <FIG. 9A: Process For Setting Radius Of Second Pointer 112 To Initial Value>

FIG. 9A shows an example of the process for setting the radius of the second pointer 112 in step S7C to an initial value.

The input assistance application 150 sets the initial value of the radius Radius of the second pointer 112 to the maximum value Rmax (step S141A). That is, Radius=Rmax. The user of the non-contact input device 100 can set Rmax for the input assistance application 150 through the settings screen displayed on the display 110.

### <FIG. 9B: Process For Setting Radius Of Second Pointer 112 To Initial Value>

FIG. 9B shows another example of the process for setting the radius of the second pointer 112 in step S7C to an initial value.

The input assistance application 150 calculates the amount of fluctuation D in the XY coordinates as a position accuracy metric (step S141B). Step S141B is a subroutine process, and the details thereof will be described later with reference to FIG. 9E. The input assistance application 150, as an example, calculates the amount of fluctuation D when the selection mode is set. The input assistance application 150 sets the maximum value Rmax of the radius of the second pointer 112 to a value obtained by multiplying the amount of fluctuation D in the XY coordinates by a constant (step S142B). That is, Rmax=D×constant. Note that the predetermined constant is a predetermined value.

The input assistance application 150 sets the radius Radius of the second pointer 112 to the maximum value Rmax set in step S142B (step S143B). That is, Radius=Rmax=D×constant. Note that in a case of performing the process in FIG. 9B, the input assistance application 150 does not perform the process that allows the user to set the maximum value Rmax.

### <FIG. 9C: Process For Setting Radius Of Second Pointer 112>

FIG. 9C is a diagram showing an example of the radius setting process for the second pointer in steps S7B and S9B.

The input assistance application 150 calculates the amount of fluctuation D in the XY coordinates as a position accuracy metric (step S141C). Step S141C is a subroutine process, and the details thereof will be described later with reference to FIG. 9E. The input assistance application 150, as an example, calculates the amount of fluctuation D when the selection mode is set.

The input assistance application 150 calculates the radius Radius of the second pointer 112 using the amount of fluctuation D obtained in step S141C (step S142C). Radius Radius=Rmin+(Rmax−Rmin)×(D/Rmax). Note that Rmin is the minimum value of the radius of the second pointer 112 and is a predetermined value as an example.

The input assistance application 150 determines whether the radius Radius calculated in step S142C is greater than the maximum value Rmax (Step S143C).

In a case where it is determined that the radius Radius is greater than the maximum value Rmax (S143C: YES), the input assistance application 150 sets the radius Radius to the maximum value Rmax (Step S144C). That is, Radius=Rmax.

Additionally, in a case where it is determined that the radius Radius is not greater than the maximum value Rmax (S143C: NO), the input assistance application 150 uses the calculated radius Radius as it is.

As described above, the input assistance application 150, as an example, calculates the amount of fluctuation D when the selection mode is set. When the second pointer 112 begins to be displayed in the selection mode, the size of the second pointer 112 gradually changes, making it easier to visually recognize the second pointer 112 having a size corresponding to the position accuracy.

Additionally, the input assistance application 150 may calculate the amount of fluctuation D when the proximity mode is set, as an example. By calculating the position accuracy before displaying the second pointer 112 in the selection mode, the second pointer 112 having a size corresponding to the position accuracy can be displayed from the time when the second pointer 112 begins to be displayed.

### <FIG. 9D: Calculation Process For Amount Of Fluctuation D Of XY Coordinates>

FIG. 9D is a diagram showing an example of the calculation process for the amount of fluctuation D in the XY coordinates. FIG. 9D shows an example of the calculation process for the amount of fluctuation D in step S141C of FIG. 8C.

The input assistance application 150 resets the amount of fluctuation DX in the X coordinate and the amount of fluctuation DY in the Y coordinate (step S151A). That is, DX=0, and DY=0.

The input assistance application 150 performs a subroutine process for calculating the accumulation of the amount of fluctuation D. This subroutine includes steps S152A, S153A, and S154A, and is executed by setting the X coordinate X(i) and Y coordinate Y(i) with i ranging from 1 to Ndev. That is, the input assistance application 150 calculates the amount of fluctuation D using the latest Ndev XY coordinates.

The input assistance application 150 determines whether the X coordinate X(i) is 0xFFFF (step S152A).

In a case where it is determined that the X coordinate X(i) is 0xFFFF (step S152A: YES), the input assistance application 150 adds a constant to the amount of fluctuation DX in the X coordinate and the amount of fluctuation DY in the Y coordinate (step S153A). That is, DX=DX+constant, and DY=DY+constant.

Additionally, in a case where it is determined that the X coordinate X(i) is not 0xFFFF (S152A: NO), the input assistance application 150 adds the square of the difference between the X(i) and the moving average Xave of the X coordinate to the amount of fluctuation DX in the X coordinate, and adds the square of the difference between the Y(i) and the moving average Yave of the Y coordinate to the amount of fluctuation DY in the Y coordinate (step S154A). That is, DX=DX+(X(i)−Xave)2, and DY=DY+(Y(i)−Yave)2.

The input assistance application 150 includes steps S152A, S153A, and S154A, and after the X coordinate X(i) and Y coordinate Y(i) are set with i ranging from 1 to Ndev, the flow proceeds to step S155A.

The input assistance application 150 calculates the amount of fluctuation D in the XY coordinates using DX and DY calculated by the subroutine process, according to the following equation (2) (step S155A).

$$D = \frac{\sqrt{\frac{D X}{N d e v}} + \sqrt{\frac{D Y}{N d e v}}}{2} \qquad ( 2 )$$

Thus, the amount of fluctuation D is obtained. By calculating DX and DY in step S154A and then calculating the amount of fluctuation D in step S155A, the standard deviation of the XY coordinates can be obtained as a position accuracy metric.

The input assistance application 150 determines whether the operation is performed with the fingertip FT held vertically near the operation surface 105A based on the amount of fluctuation D (step S156A). In a case where the amount of fluctuation D is large, the fingertip FT is either far from the operation surface 105A, the finger is not extended, or the finger is held horizontally. In a case where the amount of fluctuation D is greater than the palm threshold value (S156A: YES), a warning is displayed (step S157A). The warning is a message such as “Perform the operation with your finger held vertically and bringing your finger close to the operation surface”. Additionally, the entire screen may be turned red along with the warning.

However, in a case where the fingertip FT is suddenly brought close to the operation surface 105A from the standby mode, the amount of fluctuation D will become large, resulting in poor position accuracy. Furthermore, when the fingertip FT is kept near the operation surface 105A, the dummy data gradually substituted in step S122X will be replaced by the measured data, and the amount of fluctuation D will decrease. In this case, the positioning accuracy will gradually improve. Alternatively, the amount of fluctuation D may be determined using the process shown in FIG. 9E.

### <FIG. 9E: Modification Of Calculation Process For Amount Of Fluctuation D Of XY Coordinates>

FIG. 9E is a diagram showing an example of the calculation process for the amount of fluctuation D in the XY coordinates. FIG. 9D shows an example of the calculation process for the amount of fluctuation D in step S141C of FIG. 8C.

The process shown in FIG. 9E modifies the content of step S155A in the process shown in FIG. 9D. Therefore, the process from step S151B to S154B in FIG. 9E is identical to the process from step S151A to S154A in FIG. 9D. Therefore, the process of step S155B will be described here.

The input assistance application 150 calculates the amount of fluctuation D of the XY coordinates using DX and DY calculated by the subroutine process, according to the following equation (3) (step S155A).

$$D = D X + D Y \qquad ( 3 )$$

In FIG. 9E, the amount of fluctuation D is not divided by Ndev. For example, in a case where Ndev is a constant, the sum (total) of DX and DY, the sum being not dividing by Ndev, may be used as the amount of fluctuation D. Furthermore, the amount of fluctuation D may be either DX or DY, rather than the amount of fluctuation D in the XY coordinates. For example, the amount of fluctuation D may be either the amount of fluctuation DX in the X coordinate/Ndev or the amount of fluctuation DY in the Y coordinate/Ndev.

### <FIG. 9F: Process For Determining Whether To Display Menu>

FIG. 9F is a diagram showing an example of the process for determining whether to display a menu. FIG. 9F shows the process for determining whether to display the menu in step S23.

Here, Nmenu represents the number of pieces of data corresponding to the time slot for the process for determining whether to display the menu. Nmenu can be defined during design, or can be set by the user via a settings screen. Furthermore, Dmenu is a distance corresponding to the threshold value for the amount of movement of the X coordinate and the Y coordinate.

The input assistance application 150 performs the X coordinate determination process (determination X) while incrementing the i-number of X(i) one by one from 2 to Nmenu. The X coordinate determination process is a subroutine process.

The input assistance application 150 determines whether the absolute value of X(i)−X(1) is less than Dmenu (step S161). X(1) is the latest X coordinate.

The input assistance application 150 performs the subroutine process of the flow for the Y coordinate in a case where the absolute values of the differences between X(2) to X(Nmenu) and X(1) are all less than Dmenu (all S161: YES).

The input assistance application 150 performs the Y coordinate determination process (determination Y) while incrementing the i-number of Y(i) one by one from 2 to Nmenu. The Y coordinate determination process is a subroutine process.

The input assistance application 150 determines whether the absolute value of Y(i)−Y(1) is less than Dmenu (step S162). Y(1) is the latest Y coordinate.

In a case where the absolute values of the differences between Y(2) to Y(Nmenu) and Y(1) are all less than Dmenu (all S162: YES), the input assistance application 150 advances the flow to step S163.

The input assistance application 150 determines whether the condition that current time-SelectionTime>SelectionTH is established (step S163). In other words, in a case where the elapsed time since the selection mode was set exceeds a predetermined time, the flow proceeds to step S164.

The input assistance application 150 displays a menu (step S164). The menu is, as an example, the function menu 112C (see FIG. 6E). If the finger is moving (S161: NO, or S162: NO), or immediately after the selection mode is set (S163: NO), the function menu is not displayed.

The menu is displayed in the selection mode in a case where the Nmenu XY coordinates have not moved significantly (in a case of being stationary). That is, in the selection mode, the input assistance application 150 causes the OS 140 to display a menu in a case where the XY coordinates of the fingertip FT are at rest for the time taken to acquire Nmenu XY coordinates. The time taken to acquire the Nmenu XY coordinates is an example of a third predetermined time.

### <Settings Screen>

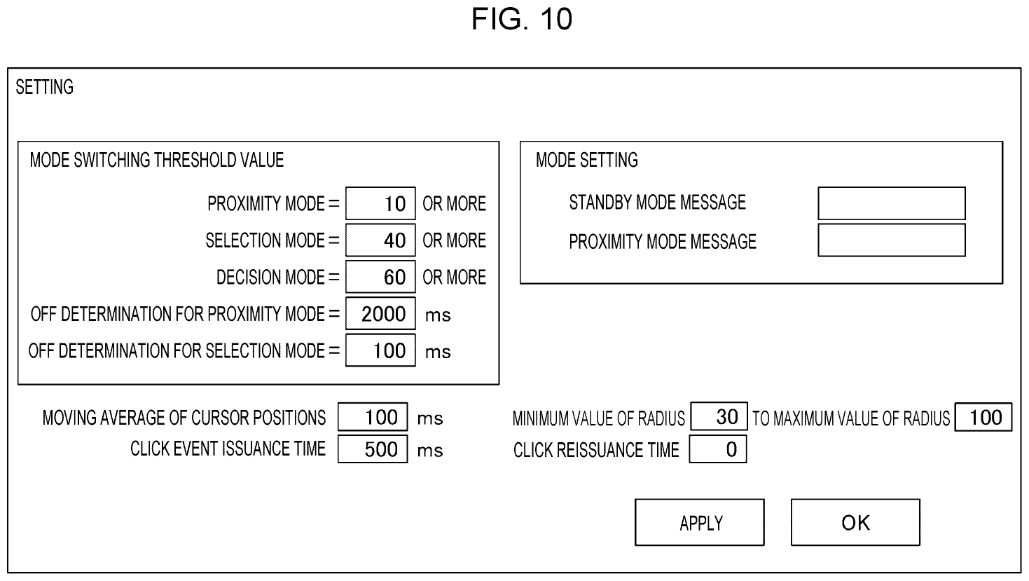

FIG. 10 is a diagram showing an example of a settings screen. The input assistance application 150 causes the OS 140 to display the settings screen shown in FIG. 10 on the display 110. The settings screen is an image representing a screen where various settings can be input.

The settings screen shown in FIG. 10 includes five text boxes for setting the mode switching threshold value, the message displayed on the display 110 in the standby mode and the proximity mode, the moving average of the position of the second pointer 112, the click event issuance time, the minimum value and the maximum value of the radius of the second pointer 112, and the text box into which the click re-output time is input. The threshold value for the proximity mode corresponds to Z value Cz3, the threshold value for the selection mode corresponds to Z value Cz2, and the threshold value for the decision mode corresponds to Z value Cz1.

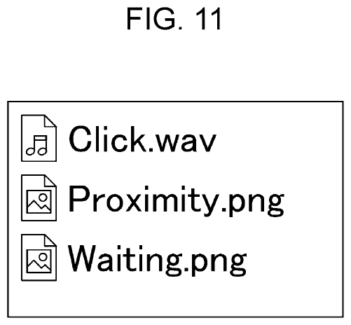

FIG. 11 is a diagram showing an example of a folder configuration. The folder is stored within the memory 132 (see FIG. 2), and the input assistance application 150 can access the folder.

FIG. 11 shows the audio file (Click.wav) selectable in the settings screen and the background image files for each mode (Proximity.png, Waiting.png). Note that while the audio file and the background image file are shown within one folder here, the audio file and the background image file may reside in separate folders.

### <Flowchart Of Setting Process>

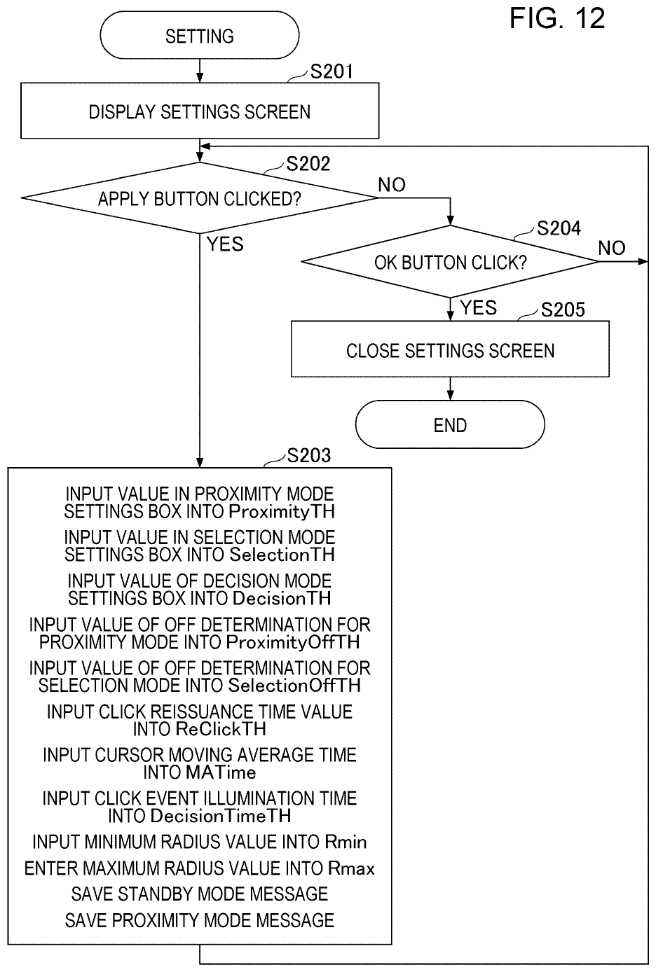

FIG. 12 is a flowchart showing an example of the setting process. When “setting” is selected from the menu in the task tray, the input assistance application 150 activates the settings program and executes the process shown in FIG. 12.

The input assistance application 150 causes the OS 140 to display the settings screen on the display 110 (step S201). The user can enter various values and other information into the settings screen shown in FIG. 10.

The input assistance application 150 determines whether the apply button has been clicked (step S202).

In a case where it is determined that the apply button has been clicked (S202: YES), the input assistance application 150 sets each value, and the like (step S203). Specifically, the input assistance application 150 inputs the value in the proximity mode settings box into ProximityTH, the value in the selection mode settings box into SelectionTH, the value in the decision mode settings box into DecisionTH, the value of the OFF determination for the proximity mode into ProximityOffTH, and the value of the OFF determination for the selection mode into SelectionOffTH. Additionally, the input assistance application 150 inputs the click re-output time value into ReClickTH, inputs the second pointer moving average time into MATime, inputs the click event issuance time value into Decision TimeTH, inputs the minimum value of the radius into Rmin, inputs the maximum value of the radius into Rmax, saves the standby mode message, and saves the proximity mode message.

Furthermore, in a case where it is determined in step S202 that the Apply button has not been clicked (S202: NO), the input assistance application 150 determines whether the OK button has been clicked (step S204). The input assistance application 150 repeats the process from step S202 onwards until the OK button is clicked.

In a case where it is determined that the OK button has been clicked (S204: YES), the input assistance application 150 causes the OS 140 to close the settings screen (step S205). After completing the process in step S205, the input assistance application 150 terminates the flow. Additionally, in a case where the OK button is clicked, each value may be set and then the flow may end.

### Effects

The non-contact input device 100 includes the operation surface 105A, the detection unit (sensor electrodes 121X and 121Y, and input sensor circuit 125A) that measures a two-dimensional position of an object with which a non-contact operation is performed on the operation surface 105A and a distance from the operation surface 105A to the object, the display 110 disposed on a back side of the operation surface 105A, and the control device 130 including the OS 140 utilizing a flat GUI and the input assistance application 150, wherein the input assistance application 150 outputs, to the OS 140, a command to display, on the display 110, a second pointer 112 in an overlay, the second pointer 112 being different from a first pointer 111 displayed by the OS 140 on the display 110, in accordance with the two-dimensional position and the distance, and, in a case where it is determined that an operation with the object was decided based on the two-dimensional position and the distance, outputs, to the OS 140, the two-dimensional position when the operation is decided and a click event.

Therefore, it is possible to provide the non-contact input device 100 that enables non-contact input through the three-dimensional operation, the non-contact input device 100 including the OS and the application program that can handle only the two-dimensional position. Furthermore, by having the application display the second pointer instead of the first pointer (mouse pointer) provided by the OS, even an OS that displays the first pointer (mouse pointer) corresponding to only a two-dimensional position can display a second pointer corresponding to a three-dimensional position.

The input assistance application 150 may output, to the OS 140, a command to hide the first pointer 111. Without modifying the OS 140, as a feature not provided by the OS 140, the second pointer that dynamically changes its size, arc length, and the like, in response to the operation input, can be displayed on the display 110.

Additionally, the decision region (first region) where the distance from the operation surface 105A to the fingertip FT is shorter than the first threshold value is a decision region where the input assistance application 150 executes the decision mode. The input assistance application 150 considers the fingertip to be in the decision region (first region) in a case where the measured capacitance is greater than the first threshold value Cz1. The input assistance application 150 displays the second pointer 112 that moves in response to the operation performed using the fingertip FT (object) when the distance from the operation surface 105A to the fingertip FT (object) is positioned in the decision region (first region). When the distance from the operation surface 105A to the fingertip FT (object) remains in the decision region (first region), the input assistance application 150 displays, as the second pointer 112A, an arc that lengthens over time, the arc being changed to an annular ring after being at rest for a first predetermined time. When the time during which the distance from the operation surface 105A to the fingertip FT (object) remains in the decision region (first region) exceeds a first predetermined time, the input assistance application 150 may determine that the operation content is decided, display the annular ring as the second pointer 112B, issue a click event to the OS 140, and output, to the OS 140, the two-dimensional position when the operation content is decided. The user can intuitively understand that holding the fingertip FT stationary in the decision region for a certain period of time will decide the operation content.

Additionally, when the distance from the operation surface 105A to the fingertip FT (object) after the click event is issued to the OS 140 remains in the decision region (first region), the input assistance application 150 causes the OS 140 to display, as the second pointer 112A, an arc that lengthens over time, the arc being changed to an annular ring a second predetermined time after drawing the arc was started, when the second predetermined time has elapsed since the click event was issued, causes the OS 140 to display the annular ring as the second pointer 112B, and outputs the two-dimensional position and the click event to the OS 140. It is possible to provide the non-contact input device 100 that enables the continuous decision operation and allows for three-dimensional operation-based non-contact input, offering improved usability.

Additionally, when the fingertip FT (object) with a distance from the operation surface 105A moves outside the decision region (first region) and then returns in the decision region (first region), the input assistance application 150 may cause the OS 140 to display, as the second pointer 112A, an arc that lengthens over time. In a case where a series of decision operations are performed, the pointer can be displayed immediately.

Additionally, the selection region (second region) where the distance from the operation surface 105A to the fingertip FT is greater than or equal to the first threshold value and shorter than the second threshold value longer than the first threshold value is the selection region where the input assistance application 150 executes the selection mode. The input assistance application 150 causes the OS 140 to display the second pointer 112 that moves according to the two-dimensional position of the object when the object is positioned in the second region, and causes the OS 140 to display the function menu in an overlay when the object remains in the second region for a third predetermined time and the two-dimensional position of the object is at rest. The input assistance application 150 may cause the OS 140 to display the second pointer 112A that moves according to the operation performed using the fingertip FT (object) when the fingertip FT (object) with a distance from the operation surface 105A is positioned in the selection region (second region), and may cause the OS 140 to display a function menu in an overlay when the fingertip FT (object) with a distance from the operation surface 105A remains stationary in the selection region (second region) for a third predetermined time. As in the second pointer 112 (112A, 112B), the function menu can be displayed without making any changes to the OS 140.

Furthermore, the input assistance application 150 calculates the amount of fluctuation in the two-dimensional positions calculated at a plurality of time points as an indicator of the fingertip FT (object)'s position accuracy when the distance from the operation surface 105A to the fingertip FT (object) is positioned in the selection region (second region). As the position accuracy metric of the fingertip FT (object) improves, the OS 140 may display the second pointer 112 smaller. Without modifying the OS 140, the second pointer 112 can be displayed by overlay so as to become smaller in accordance with position accuracy. Additionally, by displaying the second pointer 112 smaller according to position accuracy, it is possible to visually convey the position accuracy to the user.

Additionally, when the fourth predetermined time has elapsed since the fingertip FT (object) with a distance from the operation surface 105A moves from the decision region (first region) into the selection region (second region), the input assistance application 150 may transition from the decision mode to the selection mode. It is possible to reliably switch the mode from the decision mode to the selection mode.

Furthermore, the proximity region (third region) where the distance from the operation surface 105A to the fingertip FT is greater than or equal to the second threshold value and shorter than the third threshold value, which is longer than the second threshold value, is the proximity region where the input assistance application 150 executes the proximity mode. The input assistance application 150 outputs, to the OS 140, a command to display an image or a message for the proximity mode in an overlay on the display 110 when the fingertip FT is positioned in the third region. The input assistance application 150 may output, to the OS 140, a command to display an image or a message for the proximity mode in an overlay on the display 110 when the two-dimensional position of the fingertip FT (object) is positioned in the proximity region (third region). The image and the message for the proximity mode can be displayed in an overlay, so that it is possible to display the image and the message for the proximity mode to the user without modifying the OS 140. Using the image that indicates the operation method as the image for the proximity mode makes it possible to show the operation method at the appropriate timing. Additionally, when the input assistance application 150 provides an operation screen that allows easy replacement of the image and the message, the administrator of the non-contact input device 100 can display, on the display 110, the image and the message according to the application program.

The fourth region where the distance from the operation surface 105A to the fingertip FT is greater than or equal to the third threshold value is the standby region where the input assistance application 150 does not calculate the two-dimensional position of the fingertip FT (object). The input assistance application 150 outputs, to the OS, a command to display, on the display, an image or a message for the standby mode in an overlay when the object is not detected in any of the first region, the second region, and the third region. The input assistance application 150 may output, to the OS 140, a command to display, on the display 110, an image or a message for the standby mode in an overlay when the fingertip FT (object) is not detected in any of the decision region (first region), the selection region (second region), and the proximity region (third region). Without modifying the OS 140, the image and the message for the standby mode can be easily displayed to the user. Furthermore, since the input assistance application 150 can easily replace the image and the message, it is possible to display, on the display 110, the image and the message according to the application program.

Additionally, the input assistance application 150 may calculate, as the two-dimensional position of the fingertip FT (object), the moving average of the two-dimensional positions acquired at a plurality of time points, and cause the OS 140 to display the second pointer 112 (112A, 112B) at the calculated position of the two-dimensional coordinate. By calculating the moving average of the X coordinate and the Y coordinate as the XY coordinates of the fingertip FT, the XY coordinates of the fingertip FT are obtained with fluctuations caused by external noise and hand movements suppressed, and it is possible to display the second pointer 112 (112A, 112B) at the highly accurate XY coordinates with reduced influence of the amount of fluctuation.

Additionally, in a case where it is determined that the operation content with the fingertip FT (object) is decided, the input assistance application 150 may output, to the OS 140, the two-dimensional position of the fingertip FT (object) calculated as the moving average of the two-dimensional position when the operation content is decided and the click event. It is possible to output to the OS 140 that the decision operation was performed using the XY coordinates with high accuracy calculated using the moving average, thereby reflecting the content of the decision operation with high accuracy. Furthermore, since XY coordinates are not transmitted to the OS 140 until the click event is issued, the processing load on the OS 140 can be reduced.

Additionally, the input assistance application 150 may calculate the sum of the amounts of fluctuation in a plurality of two-dimensional positions as a position accuracy metric of the fingertip FT (object), using a plurality of time points whose number of pieces of data used for calculation is set by the user. The input assistance application 150 can calculate a position accuracy metric corresponding to the user-set number of two-dimensional positions. The user can adjust the level of the position accuracy metric.

Additionally, the input assistance application 150 outputs, to the OS 140, a command to display the second pointer in an overlay on the display 110 with the size of the second pointer 112 set by the user. The user can set the size of the second pointer 112 without modifying the OS 140. The user can set the size of the second pointer 112 via the input assistance application 150.

Additionally, the input assistance application 150 may regard the size of the second pointer as a size to be proportional to the inverse of the Z value (a value proportional to capacitance). In this case as well, it is possible to prompt the user to bring the fingertip FT closer to the operation surface 105A. However, the size of the second pointer based on the Z value has no statistical significance.

Although the non-contact input device and the input assistance application according to the exemplary embodiment of the present disclosure have been described above, the present disclosure is not limited to the specifically disclosed embodiments, but various modifications and changes are possible without deviation from the scope of the claims.

This international application claims priority from Japanese Patent Application 2023-078754 filed on May 11, 2023, the entire content of which is hereby incorporated by reference into this international application.

What is claimed is:

1. A non-contact input device comprising:
an operation surface;
a detection unit that measures a two-dimensional position of an object with which a non-contact operation is performed on the operation surface and a distance from the operation surface to the object;
a display disposed on a back side of the operation surface;
a control device including an OS utilizing a flat GUI and an input assistance application, wherein
the input assistance application
outputs, to the OS, a command to display, on the display, a second pointer in an overlay, the second pointer being different from a first pointer displayed by the OS on the display, in accordance with the two-dimensional position and the distance, and
in a case where it is determined that an operation with the object was decided based on the two-dimensional position and the distance, outputs, to the OS, the two-dimensional position when the operation is decided and a click event.

2. The non-contact input device according to claim 1, wherein the input assistance application outputs a command to hide the first pointer to the OS.

3. The non-contact input device according to claim 1, wherein
a first region where the distance is shorter than a first threshold value is a decision region where the input assistance application outputs a click event, and wherein
the input assistance application
causes the OS to display the second pointer that moves according to an operation performed using the object when the object is positioned in the first region,
causes the OS to display, as the second pointer, an arc that lengthens over time when the object remains in the first region, the arc being changed to an annular ring a first predetermined time after the object entered the first region, and
determines that the operation is decided when a time during which the object remains in the first region exceeds the first predetermined time, displays the annular ring as the second pointer via the OS, issues a click event to the OS, and outputs, to the OS, the two-dimensional position when the operation is decided.

4. The non-contact input device according to claim 3, wherein
the input assistance application
causes the OS to display, as the second pointer, an arc that lengthens over time when the object remains in the first region after a click event is issued to the OS, the arc being changed to an annular ring a second predetermined time after drawing the arc was started, when the second predetermined time has elapsed since the click event was issued,
causes the OS to display the annular ring as the second pointer, and outputs the two-dimensional position and the click event to the OS.

5. The non-contact input device according to claim 4, wherein the input assistance application causes the OS to display, as the second pointer, an arc that lengthens over time when the object is outside the first region and then returns in the first region.

6. The non-contact input device according to claim 3, wherein
in a case where the first predetermined time is set to zero,
the input assistance application determines that the operation is decided in a case where the object is positioned in the first region, issues a click event to the OS, and
outputs the two-dimensional position when the operation is decided to the OS.

7. The non-contact input device according to claim 3, wherein the input assistance application causes the OS to display, as the second pointer, a circle smaller than the annular ring after outputting the click event.

8. The non-contact input device according to claim 3, wherein
a second region where the distance is greater than or equal to the first threshold value and smaller than a second threshold value longer than the first threshold value is a selection region in which the input assistance application executes a selection mode, and wherein
the input assistance application
transitions from a decision mode in which the click event is output to the selection mode when a fourth predetermined time has elapsed since the object moved from the first region to the second region.

9. The non-contact input device according to claim 8, wherein
the input assistance application
calculates, as a position accuracy metric of the object, a sum of amounts of fluctuation in a plurality of the two-dimensional positions calculated at a plurality of time points when the object is positioned in the second region, and
causes the OS to display the second pointer smaller as position accuracy of the object improves.

10. The non-contact input device according to claim 8, wherein
the input assistance application
causes the OS to display the second pointer that moves according to a two-dimensional position of the object when the object is positioned in the second region, and
when the object remains in the second region for a third predetermined time and the two-dimensional position of the object is at rest, causes the OS to display a function menu in an overlay.

11. The non-contact input device according to claim 8, wherein
a third region where the distance is greater than or equal to the second threshold value and shorter than a third threshold value longer than the second threshold value is a proximity region where the input assistance application executes a proximity mode, and wherein
the input assistance application outputs, to the OS, a command to display an image or a message for a proximity mode in an overlay on the display when the object is positioned in the third region.

12. The non-contact input device according to claim 11, wherein
a fourth region where the distance is greater than or equal to the third threshold value is a standby region where the input assistance application does not output a two-dimensional position of the object, and wherein
the input assistance application outputs, to the OS, a command to display, on the display, an image or a message for a standby mode in an overlay when the object is not detected in the first region, the second region, and the third region.

13. The non-contact input device according to claim 9, wherein
the input assistance application
calculates, as a two-dimensional position of the object, a moving average of the two-dimensional positions acquired at a plurality of time points, and
displays the second pointer at the calculated two-dimensional coordinate position via the OS.

14. The non-contact input device according to claim 13, wherein in a case where it is determined that an operation with the object is decided, the input assistance application outputs, to the OS, the two-dimensional position of the object calculated as the moving average of the two-dimensional position when the operation is decided and the click event.

15. The non-contact input device according to claim 14, wherein the input assistance application calculates a sum of amounts of fluctuation in a plurality of the two-dimensional positions as a position accuracy metric of the object using the plurality of time points in which the number of pieces of data used for calculation is set by the user.

16. The non-contact input device according to claim 1, wherein the input assistance application outputs, to the OS, a command to display the second pointer in an overlay on the display at a size of the second pointer set by the user.

17. An input assistance application for operating an application program operating on an OS utilizing a flat GUI by a detection unit that measures a two-dimensional position of an object performing a non-contact operation input on an operation surface and a distance from the operation surface to the object, wherein
the input assistance application
outputs, to the OS, a command to display, on the display, a second pointer in an overlay, the second pointer being different from a first pointer displayed by the OS on the display, according to the two-dimensional position and the distance, and
in a case where it is determined that an operation with the object was decided based on the two-dimensional position and the distance, outputs, to the OS, the two-dimensional position when the operation is decided and a click event.
